(19) United States
(12) Patent Application Publication
(10) Pub. No.: US 2016/0205341 A1
(43) Pub. Date: Jul. 14, 2016

(54) SYSTEM AND METHOD FOR REAL-TIME PROCESSING OF ULTRA-HIGH RESOLUTION DIGITAL VIDEO

(71) Applicant: SMARTER TV LTD., Petach Tikva (IL)

(72) Inventors: Elad Moshe HOLLANDER, En Vered (IL); Victor SHENKAR, Ramat Gan (IL)

(21) Appl. No.: 14/913,276

(22) PCT Filed: Aug. 20, 2014
(86) PCT No.: PCT/IL2014/000042

§ 371 Date: Feb. 19, 2016

Related U.S. Application Data
(60) Provisional application No. 61/959,296, filed on Aug. 20, 2013.

(51) Int. Cl. H04N 7/015; H04N 19/31; H04N 19/527; H04N 19/593; H04N 19/46; H04N 13/00; H04N 21/235; H04N 21/435; H04N 13/02; H04N 19/23; H04N 19/44

(52) U.S. Cl. CPC H04N 7/015; H04N 19/23; H04N 19/31; H04N 19/527; H04N 19/593; H04N 19/44; H04N 13/0066; H04N 13/0048; H04N 13/0029; H04N 13/0011; H04N 21/2353; H04N 21/435; H04N 13/0203; H04N 19/46

(57) ABSTRACT

A method for encoding a video stream generated from at least one ultra-high resolution camera capturing sequential image frames from a fixed viewpoint of a scene includes decomposing the sequential image frames into quasi-static background and dynamic image features; distinguishing between different objects represented by the dynamic image features by recognizing characteristics and tracking movement of the objects in the sequential image frames. The dynamic image features are formatted into a sequence of miniaturized image frames that reduces at least one of: inter-frame movement of the objects; and high spatial frequency data. The sequence is compressed into a dynamic data layer and the quasi-static background into a quasi-static data layer. The dynamic data layer and the quasi-static data layer are encoded with setting metadata pertaining to the scene and the at least one ultra-high resolution camera, and corresponding consolidated formatting metadata pertaining to the decomposing and formatting procedures.

### FIELD OF THE DISCLOSED TECHNIQUE

The disclosed technique relates to digital video processing, in general, and to a system and method for real-time processing of ultra-high resolution digital video, in particular.

### BACKGROUND OF THE DISCLOSED TECHNIQUE

Video broadcast of live events in general and sports events in particular, such as in televised transmissions, have been sought after by different audiences from diverse walks of life. To meet this demand, a wide range of video production and dissemination means have been developed. The utilization of modern technologies for such uses does not necessarily curtail the exacting logistic requirements associated with production and broadcasting of live events, such as in sport matches or games that are played on sizeable playing fields (e.g., soccer/football). Live production and broadcasting of such events generally require a qualified multifarious staff and expensive equipment to be deployed on-site, in addition to staff simultaneously employed in television broadcasting studios that may be located off-site. Digital distribution of live sports broadcasts, especially in the high-definition television (HDTV) format typically incurs for end-users consumption of a large portion of the total available bandwidth. This may be especially pronounced during prolonged use by a large number of concurrent end-users. TV-over-IP (television over Internet protocol) of live events may still suffer (at many Internet service provider locations) from bottlenecks that may arise from insufficient bandwidth, which ultimately results in an impaired video quality of the live event as well as a degraded user experience.

Systems and methods for encoding and decoding of video are generally known in the art. An article entitled “An Efficient Video Coding Algorithm Targeting Low Bitrate Stationary Cameras” by Nguyen N., Bui D., and Tran X. is directed at a video compression and decompression algorithm for reducing bitrates in embedded systems. Multiple stationary cameras capture scenes that each respectively contains a foreground and a background. The background represents a stationary scene, which changes slowly in comparison with the foreground that contains moving objects. The algorithm includes a motion detection and extraction module, and a JPEG (Joint Photographic Experts Group) encoding/decoding module. A source image captured from a camera is inputted into the motion detection and extraction module. This module extracts moving a block and a stationary block from the source image. The moving block is then subtracted by a corresponding block from a reconstructed image, where residuals are fed into the JPEG encoding module to reduce the bitrate further by data compression. This data is transmitted to the JPEG decoding module, where the moving block and the stationary block are separated based on inverse entropy encoding. The moving block is then rebuilt by subjecting it to an inverse zigzag scan, inverse quantization and an inverse discrete cosine transform (IDCT). The decoded moving block is combined with its respective decoded stationary block to form a decoded image.

U.S. Patent Application Publication No.: US 2002/0051491 A1 entitled “Extraction of Foreground Information for Video Conference” to Challapali et al. is directed at an image processing device for improving the transmission of image data over a low bandwidth network by extracting foreground information and encoding it at a higher bitrate than background information. The image processing device includes two cameras, a foreground information detector, a discrete cosine transform (DCT) block classifier, an encoder, and a decoder. The cameras are connected with the foreground information detector, which in turn is connected with DCT block classifier, which in turn is connected with encoder. The encoder is connected to the decoder via a channel. The two cameras are slightly spaced from one another and are used to capture two images of a video conference scene that includes a background and a foreground. The two captured images are inputted to the foreground information detector for comparison, so as to locate pixels of foreground information. Due to the closely co-located cameras, pixels of foreground information have larger disparity than pixels of background information. The foreground information detector outputs to the DCT block classifier one of the images and a block of data which indicates which pixels are foreground pixels and which are background pixels. The DCT block classifier creates 8×8 DCT blocks of the image as well as binary blocks that indicate which DCT blocks of the image are foreground and which are background information. The encoder encodes the DCT blocks as either a foreground block or a background block according to whether a number of pixels of a particular block meet a predefined threshold or according to varying bitrate capacity. The encoded DCT blocks are transmitted as a bitstream to the decoder via the channel. The decoder receives the bitstream and decodes it according to the quantization levels provided therein. Thusly, most of the bandwidth of the channel is dedicated to the foreground information and only a small portion is allocated to background information.

### SUMMARY OF THE PRESENT DISCLOSED TECHNIQUE

It is an object of the disclosed technique to provide a novel method and system for providing ultra-high resolution video. In accordance with the disclosed technique, there is thus provided method for encoding a video stream generated from at least one ultra-high resolution camera that captures a plurality of sequential image frames from a fixed viewpoint of a scene. The method includes the following procedures. The sequential image frames are decomposed into quasi-static background and dynamic image features. Different objects represented by the dynamic image features are distinguished (differentiated) by recognizing characteristics of the objects and by tracking movement of the objects in the sequential image frames. The dynamic image features are formatted into a sequence of miniaturized image frames that reduces at least one of: the inter-frame movement of the objects in the sequence of miniaturized image frames, and the high spatial frequency data in the sequence of miniaturized image frames (without degrading perceptible visual quality of the dynamic features). The sequence of miniaturized image frames is compressed into a dynamic data layer and the quasi-static background into a quasi-static data layer. Then, the dynamic data layer and the quasi-static data layer with setting metadata pertaining to the scene and to at least one ultra-high resolution camera, and corresponding consolidated formatting metadata pertaining to the decomposing procedure and the formatting procedure are encoded.

In accordance with the disclosed technique, there is thus provided a system for providing ultra-high resolution video. The system includes multiple ultra-high resolution cameras, each of which captures a plurality of sequential image frames from a fixed viewpoint of an area of interest (scene), a server node coupled with the ultra-high resolution cameras, and at least one client node communicatively coupled with the server node. The server node includes a server processor and a (server) communication module. The client node includes a client processor and a client communication module. The server processor is coupled with the ultra-high resolution cameras. The server processor decomposes in real-time the sequential image frames into quasi-static background and dynamic image features thereby yielding decomposition metadata. The server processor then distinguishes in real-time between different objects represented by the dynamic image features by recognizing characteristics of the objects and by tracking movement of the objects in the sequential image frames. The server processor formats (in real-time) the dynamic image features into a sequence of miniaturized image frames that reduces at least one of inter-frame movement of the objects in the sequence of miniaturized image frames, and high spatial frequency data in the sequence of miniaturized image frames (substantially without degrading visual quality of the dynamic image features), thereby yielding formatting metadata. The server processor compresses (in real-time) the sequence of miniaturized image frames into a dynamic data layer and the quasi-static background into a quasi-static data layer. The server processor then encodes (in real-time) the dynamic data layer and the quasi-static data layer with setting metadata pertaining to the scene and to at least one ultra-high resolution camera, and corresponding formatting metadata and decomposition metadata. The server communication module transmits (in real-time) the encoded dynamic data layer, the encoded quasi-static data layer and the metadata to the client node. The client communication module receives (in real-time) the encoded dynamic data layer, the encoded quasi-static data layer and the metadata. The client processor, which is coupled with the client communication module, decodes and combines (in real-time) the encoded dynamic data layer and the encoded quasi-static data layer, according to the decomposition metadata and the formatting metadata, so as to generate (in real-time) an output video stream.

### BRIEF DESCRIPTION OF THE DRAWINGS

The disclosed technique will be understood and appreciated more fully from the following detailed description taken in conjunction with the drawings in which:

FIG. 1 is a schematic diagram of a system for providing ultra-high resolution video over a communication medium, generally referenced 100, constructed and operative in accordance with an embodiment of the disclosed technique;

FIG. 2 is a schematic diagram detailing a server image processing unit that is constructed and operative in accordance with the embodiment of the disclosed technique;

FIG. 3 is a schematic diagram representatively illustrating implementation of image processing procedures by the server image processing unit of FIG. 2, in accordance with the principles of the disclosed technique;

FIG. 4A is a schematic diagram of a general client configuration that is constructed and operative in accordance with the embodiment of the disclosed technique;

FIG. 4B is a schematic diagram detailing a client image processing unit of the general client configuration of FIG. 4A, constructed and operative in accordance with the disclosed technique;

FIG. 5A is a schematic diagram representatively illustrating implementation of image processing procedures at by the client image processing unit of FIG. 4B, in accordance with the principles of the disclosed technique;

FIG. 5B is a schematic diagram illustrating a detailed view of the implementation of image processing procedures of FIG. 5A specifically relating to the aspect of a virtual camera configuration, in accordance with the embodiment of the disclosed technique;

FIG. 6A is a schematic diagram illustrating incorporation of special effects and user-requested data into an outputted image frame of a video stream, constructed and operative in accordance with the embodiment of the disclosed technique;

FIG. 6B is a schematic diagram illustrating an outputted image of a video stream in a particular viewing mode, constructed and operative in accordance with the embodiment of the disclosed technique;

FIG. 7 is a schematic diagram illustrating a simple special case of image processing procedures excluding aspects related to the virtual camera configuration, constructed and operative in accordance with another embodiment of the disclosed technique;

FIG. 8 is a schematic block diagram of a method for encoding a video stream generated from at least one ultra-high resolution camera capturing a plurality of sequential image frames from a fixed viewpoint of a scene;

FIG. 9A is a schematic illustration depicting an example installation configuration of the image acquisition sub-system of FIG. 1 in relation to a soccer/football playing field, constructed and operative in accordance with another embodiment of the disclosed technique;

FIG. 9B is a schematic illustration depicting an example coverage area of the playing field of FIG. 9A by two ultra-high resolution cameras of the image acquisition sub-system of FIG. 1;

FIG. 10A is a schematic diagram illustrating the applicability of the disclosed technique to the field of broadcast sports, particularly to soccer/football, constructed and operative in accordance with another embodiment of the disclosed technique;

FIG. 10B is a schematic diagram illustrating the applicability of the disclosed technique in the field of broadcast sports, particularly to soccer/football, in accordance with and continuation to the embodiment of the disclosed technique shown in FIG. 10A;

FIG. 11 is a schematic illustration in perspective view depicting an example installation configuration of the image acquisition sub-system of FIG. 1 in relation to a basketball court, constructed and operative in accordance with a further embodiment of the disclosed technique;

FIG. 12 is a schematic diagram illustrating the applicability of the disclosed technique to the field of broadcast sports, particularly to ice hockey, constructed and operative in accordance with another embodiment of the disclosed technique;

FIG. 13 is a schematic diagram illustrating the applicability of the disclosed technique to the field of card games, particularly to blackjack, constructed and operative in accordance with a further embodiment of the disclosed technique;

FIG. 14 is a schematic diagram illustrating the applicability of the disclosed technique to the field of casino games, particularly to roulette, constructed and operative in accordance with another embodiment of the disclosed technique;

FIG. 15 is a schematic diagram illustrating a particular implementation of multiple ultra-high resolution cameras fixedly situated to capture images from several different points-of-view of an AOI, in particular a soccer/football playing field, constructed and operative in accordance with a further embodiment of the disclosed technique;

FIG. 16 is a schematic diagram illustrating a stereo configuration of the image acquisition sub-system, constructed and operative in accordance with another embodiment of the disclosed technique;

FIG. 17A is a schematic diagram illustrating a calibration configuration between two ultra-high resolution cameras, constructed and operative in accordance a further embodiment of the disclosed technique; and

FIG. 17B is a schematic diagram illustrating a method of calibration between two image frames captured by two adjacent ultra-high resolution cameras, constructed and operative in accordance with embodiment of the disclosed technique.

### DETAILED DESCRIPTION OF THE EMBODIMENTS

The disclosed technique overcomes the disadvantages of the prior art by providing a system and a method for real-time processing of a video stream generated from at least one ultra-high resolution camera (typically a plurality thereof), capturing a plurality of sequential image frames from a fixed viewpoint of a scene that significantly reduces bandwidth usage while delivering high quality video, provides unattended operation, user-to-system adaptability and interactivity, as well as conformability to the end-user platform. The disclosed technique has the advantages of being relatively low-cost in comparison to systems that require manned operation, involves simple installation process, employs off-the-shelf hardware components, offers better reliability in comparison to systems that employ moving parts (e.g., tilting, panning cameras), and allows for virtually universal global access to the contents produced by the system. The disclosed technique has myriad of applications ranging from real-time broadcasting of sporting events to security-related surveillance.

Essentially, the system includes multiple ultra-high resolution cameras, each of which captures a plurality of sequential image frames from a fixed viewpoint of an area of interest (scene), a server node coupled with the ultra-high resolution cameras, and at least one client node communicatively coupled with the server node. The server node includes a server processor and a (server) communication module. The client node includes a client processor and a client communication module. The server processor is coupled with the ultra-high resolution cameras. The server processor decomposes in real-time the sequential image frames into quasi-static background and dynamic image features thereby yielding decomposition metadata. The server processor then distinguishes in real-time between different objects represented by the dynamic image features by recognizing characteristics of the objects and by tracking movement of the objects in the sequential image frames. The server processor formats (in real-time) the dynamic image features into a sequence of miniaturized image frames that reduces at least one of inter-frame movement of the objects in the sequence of miniaturized image frames, and high spatial frequency data in the sequence of miniaturized image frames (substantially without degrading visual quality of the dynamic image features), thereby yielding formatting metadata. The server processor compresses (in real-time) the sequence of miniaturized image frames into a dynamic data layer and the quasi-static background into a quasi-static data layer. The server processor then encodes (in real-time) the dynamic data layer and the quasi-static data layer with corresponding decomposition metadata, formatting and setting metadata. The server communication module transmits (in real-time) the encoded dynamic data layer, the encoded quasi-static data layer and the metadata to the client node. The client communication module receives (in real-time) the encoded dynamic data layer, the encoded quasi-static data layer and the metadata. The client processor, which is coupled with the client communication module, decodes and combines (in real-time) the encoded dynamic data layer and the encoded quasi-static data layer, according to the decomposition metadata and the formatting metadata, so as to generate (in real-time) an output video stream that either reconstructs the original sequential image frames or renders sequential image frames according to a user's input.

The disclosed technique further provides a method for encoding a video stream generated from at least one ultra-high resolution camera that captures a plurality of sequential image frames from a fixed viewpoint of a scene. The method includes the following procedures. The sequential image frames are decomposed into quasi-static background and dynamic image features, thereby yielding decomposition metadata. Different objects represented by the dynamic image features are distinguished (differentiated) by recognizing characteristics of the objects and by tracking movement of the objects in the sequential image frames. The dynamic image features are formatted into a sequence of miniaturized image frames that reduces at least one of: the inter-frame movement of the objects in the sequence of miniaturized image frames, and the high spatial frequency data in the sequence of miniaturized image frames (without degrading perceptible visual quality of the dynamic features). The formatting procedure produces formatting metadata relating to the particulars of the formatting. The sequence of miniaturized image frames is compressed into a dynamic data layer and the quasi-static background into a quasi-static data layer. Then, the dynamic data layer and the quasi-static data layer with corresponding consolidated formatting metadata (that includes decomposition metadata pertaining to the decomposing procedure and formatting metadata corresponding to the formatting procedure), and the setting metadata are encoded.

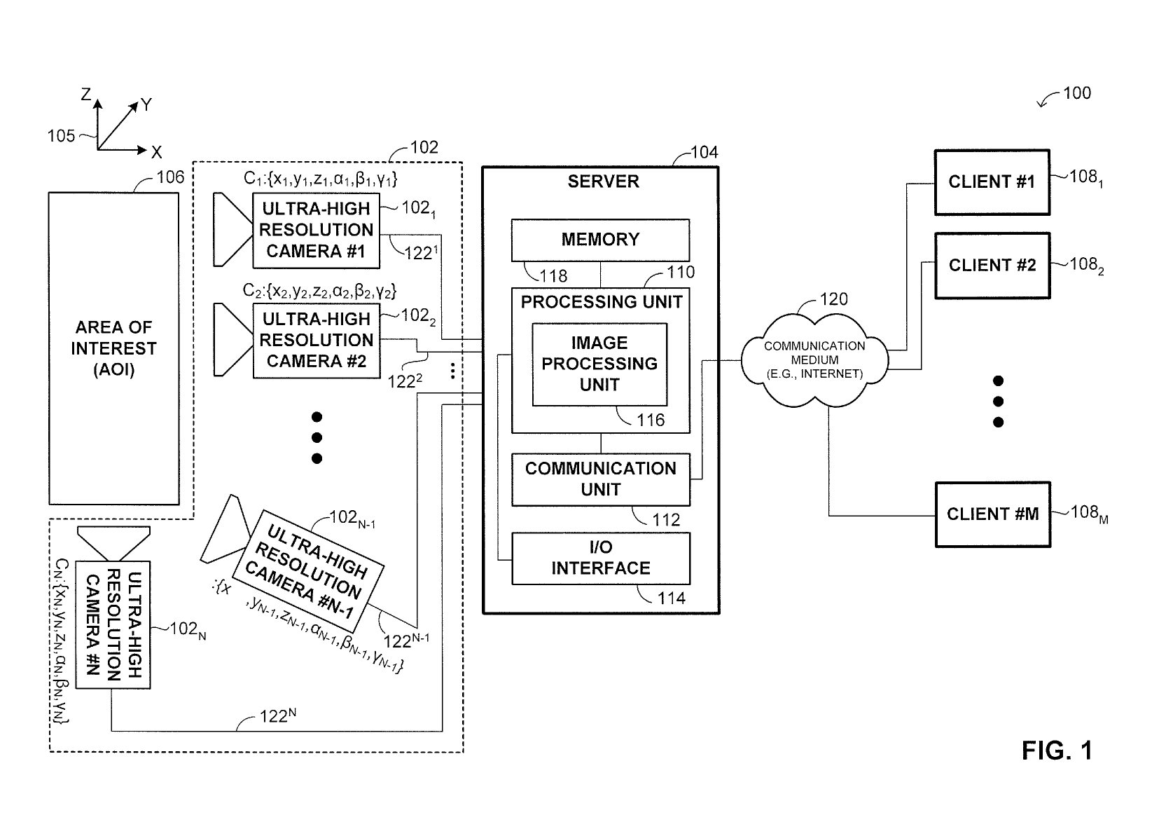

Although the disclosed technique is primarily directed at encoding and decoding of ultra-high resolution video, its principles likewise apply to non-real-time (e.g., recorded) ultra-high resolution video. Reference is now made to FIG. 1, which is a schematic diagram of a general overview of a system for providing ultra-high resolution video to a plurality of end-users over a communication medium, generally referenced 100, constructed and operative in accordance with an embodiment of the disclosed technique. System 100 includes an image acquisition sub-system 102 that includes a plurality of ultra-high resolution cameras 102₁, 102₂, . . . , 104_{N-1}, 102_{N}, (where index N is a positive integer, such that N≧1), a server 104, and a plurality of clients 108₁, 108₂, . . . , 108_{M} (where index M is a positive integer, such that M≧1). Image acquisition sub-system 102 along with server 104 is referred herein as the “server side” or “server node”, while the plurality of clients 108₁, 108₂, . . . , 108_{M} is referred herein as the “client side” or “client node”. Server 104 includes a processing unit 110, a communication unit 112, an input/output (I/O) interface 114, and a memory device 118. Processing unit 110 includes an image processing unit 116. Image acquisition sub-system 102 is coupled with server 104. In particular, ultra-high resolution cameras 102₁, 102₂, . . . , 102_{N-1}, 102_{N} are each coupled with server 104. Clients 108₁, 108₂, . . . , 108_{M} are operative to connect and communicate with server 104 via a communication medium 120 (e.g., Internet, intranet, etc.). Alternatively, at least part of clients 108₁, 108₂, . . . , 108_{M} are coupled with server 104 directly (not shown). Server 104 is typically embodied as computer system. Clients 108₁, 108₂, . . . , 108_{M} may be embodied in a variety of forms (e.g., computers, tablets, cellular phones (“smartphones”), desktop computers, laptop computers, Internet enabled televisions, streamers, television boxes, etc.). Ultra-high resolution cameras 102₁, 102₂, . . . , 102_{N-1}, 102_{N} are stationary (i.e., do not move, pan, tilt, etc.) and are each operative to generate a video stream that includes a plurality of sequential image frames from a fixed viewpoint (i.e., do not change FOV (e.g., optical zooming) during their operating), of an area of interest (AOI) 106 (i.e., herein denoted also as a “scene”). Technically, image acquisition sub-system 102 is constructed, operative and positioned such to allow for video capture coverage of the entire AOI 106, as will be described in greater detail herein below. The positions and orientations of ultra-high resolution cameras 102₁, 102₂, . . . , 102_{N-1}, 102_{N} are uniquely determined with respect to AOI 106 in relation to a 3-D (three dimensional) coordinate system 105 (also referred herein as “global reference frame” or “global coordinate system”). (Furthermore, each camera has its own intrinsic 3-D coordinate system (not shown)). Specifically, the position and orientation of ultra-high resolution camera 102₁ is determined by the Euclidean coordinates and Euler angles denoted by C₁:{x₁,y₁,z₁,α₁,β₁,γ₁}, the position and orientation of ultra-high resolution camera 102₂ is specified by C₂:{x₂,y₂,z₂,α₂,β₂,γ₂}, and so forth to ultra-high resolution camera 102_{N} whose position and orientation is specified by C_{N}:{x_{N},y_{N},z_{N},α_{N},β₁,γ_{N}}. Various spatial characteristics of AOI 106 are also known to system 100 (e.g., by user input, computerized mapping, etc.). Such spatial characteristics may include basic properties such as length, width, height, ground topology, the positions and structural dimensions of static objects (e.g., buildings), and the like.

The term “ultra-high resolution” with regard to video capture refers herein to resolutions of captured video images that are considerably higher than the standard high-definition (HD) video resolution (1920×1080, also known as “full HD”). For example, the disclosed technique directs typically at video image frame resolutions of at least 4k (2160p, 3840×2160 pixels). In other words, each captured image frame of the video stream is on the order of 8M pixels (megapixels). Other image frame aspect ratios (e.g., 3:2, 4:3) that achieve captured image frames having resolutions on the order of 4K are also viable. In other preferred implementations of the disclosed technique, ultra-high resolution cameras are operative to capture 8k video resolution (4320p, 7680×4320). Other image frame aspect ratios that achieve captured image frames having resolution on the order of 8k are also viable. It is emphasized that the principles and implementations of the disclosed technique are not limited to a particular resolution and aspect ratio, but rather, apply likewise to diverse high resolutions (e.g., 5k, 6k, etc.) and image aspect ratios (e.g., 21:9, 1.43:1, 1.6180:1, 2.39:1, 2.40:1, 1.66:1, etc.).

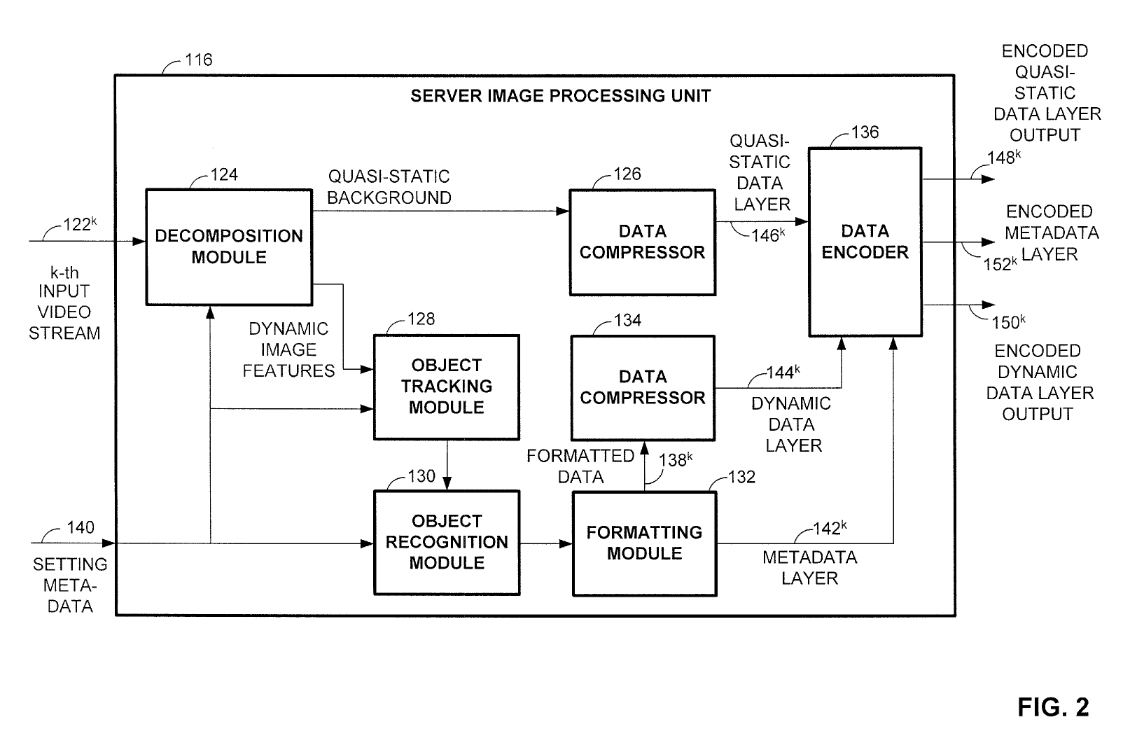

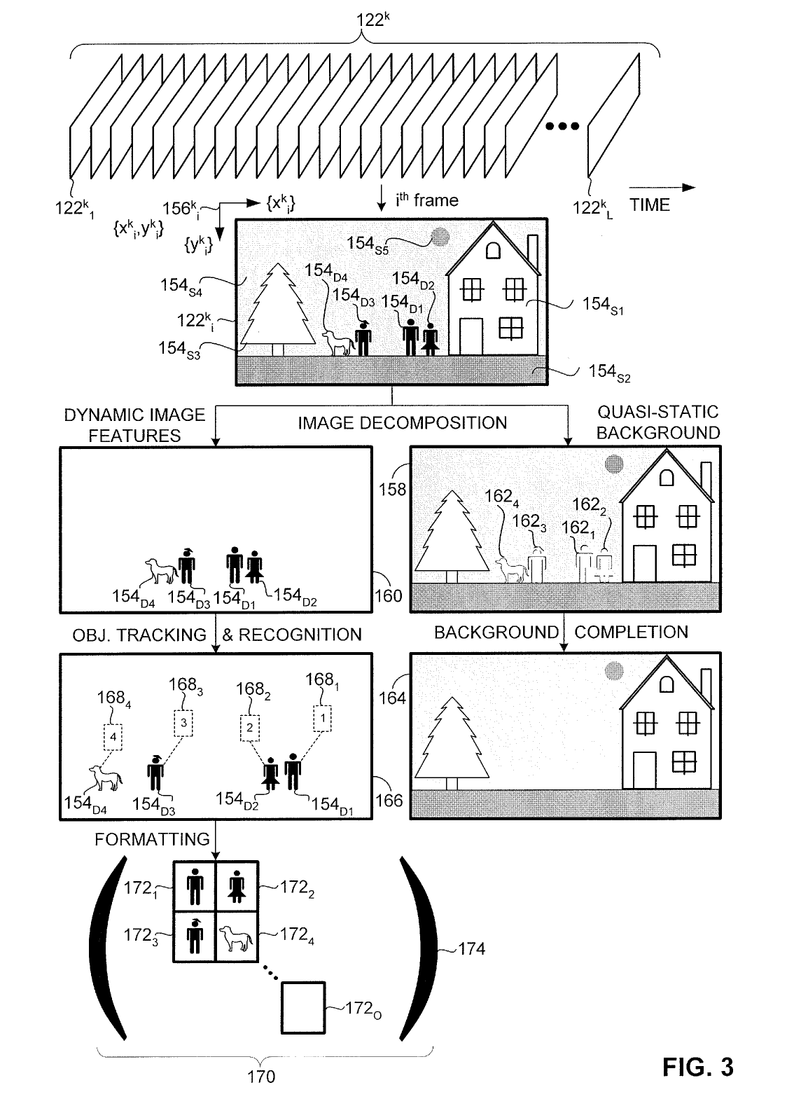

Reference is now further made to FIGS. 2 and 3. FIG. 2 is a schematic diagram detailing an image processing unit, generally referenced 116, that is constructed and operative in accordance with the embodiment of the disclosed technique. FIG. 3 is a schematic diagram representatively illustrating implementation of image processing procedures in accordance with the principles of the disclosed technique. Image processing unit 116 (also denoted as “server image processing unit”, FIG. 2) includes a decomposition module 124, a data compressor 126, an object tracking module 128, and object recognition module 130, a formatting module 132, a data compressor 134, and a data encoder 136. Decomposition module 124 is coupled with data compressor 124 and with object tracking module 128. Object tracking module 128 is coupled with object recognition module 130, which in turn is coupled with formatting module 132. Formatting module 132 is coupled with data compressor 134 and with data encoder 136.

Data pertaining to the positions and orientations of ultra-high resolution cameras 102₁, 102₂, . . . , 102_{N-1}, 102_{N} in coordinate system 105 (i.e., C₁, C₂, . . . , C_{N}) as well as to the spatial characteristics of AOI 106 are inputted into system 100 and stored in memory device 118 (FIG. 1), herein denoted as setting metadata 140 (FIG. 2). Hence, setting metadata 140 encompasses all relevant data that describes various parameters of the setting or environment that includes AOI 106 and ultra-high resolution cameras 102₁, 102₂, . . . , 102_{N-1}, 102_{N} and their relation therebetween.

Each one of ultra-high resolution cameras 102₁, 102₂, . . . , 102_{N-1}, 102_{N} (FIG. 1) captures respective video streams 122¹, 122², . . . , 122^{N-1}, 122^{N} from respective fixed viewpoints of AOI 106. Generally, each video stream includes a sequence of image frames. The topmost part of FIG. 3 illustrates a k^{th} video stream comprising of a plurality of individual image frames 122^{k}₁, . . . , 122^{k}_{L}, where superscript k is an integer between 1 and N that represents an index video stream generated from a respective (same sub-indexed) ultra-high resolution camera. The subscript i in 122^{k}ᵢ denotes the i-th image frame within the sequence of image frames (1 through integer L) of the k-th video stream to which it belongs. (According to a designation convention used herein, the index T denotes a general running index that is not bound to a particular reference number). Hence, the superscript designates a particular video stream and the subscript designates a particular image frame in the video stream. For example, an image frame denoted by 122²₁₆₇ would signify the 167^{th} image frame in the video stream 122² generated by ultra-high resolution camera 122₂. Video streams 122¹, 122², . . . , 122^{N-1}, 122^{N} are transmitted to server 104, where processing unit 110, (especially image processing unit 116) is operative to apply image processing methods and techniques thereon, the particulars of which will be described hereinbelow.

FIG. 3 shows a representative (i-th) image frame 122^{k}ᵢ captured from a k-th ultra-high resolution camera 102ₖ illustrating a scene that includes a plurality of dynamic image features 154_{D1}, 154_{D2}, 154_{D3}, 154_{D4} and a quasi-static background that includes a plurality of quasi-static background features 154_{S1}, 154_{S2}, 154_{S3}, 154_{S4}. For each image frame 122^{k}ᵢ there is defined a respective two-dimensional (2-D) image coordinate system 156^{k}ᵢ (an “image space”) specifying corresponding horizontal coordinate values x^{k}ᵢ and vertical coordinate values y^{k}ᵢ, also denoted by coordinate pairs {x^{k}ᵢ, y^{k}ᵢ}. The term “dynamic image feature” refers to an element (e.g., a pixel) or group of elements (e.g., pixels) in an image frame that changes from a particular image frame to another subsequent image frame. A subsequent image frame may not necessarily be a direct successive frame. An example of a dynamic image feature is a moving object, a so-called “foreground” object captured in the video stream. A moving object captured in a video stream may be defined as an object whose spatial or temporal attributes change from one frame to another frame. An object is a pixel or group of pixels (e.g., cluster) having at least one identifier exhibiting at least one particular characteristic (e.g., shape, color, continuity, etc.). The term “quasi-static background feature” refers to an element or group of elements in an image frame that exhibits a certain degree of temporal persistence such that any incremental change thereto (e.g., in motion, color, lighting, configuration) is substantially slow relative to the time scale of the video stream (e.g., frames per second, etc.). To an observer, quasi-static background features exhibit an unperceivable or almost unperceivable change between successive image frames (i.e., they do not change or barely change from a particular image frame to another subsequent image frame). An example of a quasi-static background feature is a static object captured in the video stream (e.g., background objects in a scene such as a house, an unperceivably slow-growing grass field, etc.). In a time-wise perspective, dynamic image features in a video stream are perceived to be rapidly changing between successive image frames whereas quasi-static background features are perceived to be relatively slowly changing between successive image frames.

Decomposition module 124 (FIG. 2) receives setting metadata 140 from memory device 118 and video streams 122¹, 122², . . . , 122^{N-1}, 122^{N} respectively outputted by ultra-high resolution cameras 102₁, 102₂, . . . , 102_{N-1}, 102_{N} and decomposes (in real-time) each frame 122^{k}ᵢ into dynamic image features and quasi-static background, thereby yielding decomposition metadata (not shown). Specifically, and without loss of generality, for a k-th input video stream 122^{k} (FIG. 3) inputted to decomposition module 124 (FIG. 2), each i-th image frame 122^{k}ᵢ is decomposed into a quasi-static background 158 that includes a plurality of quasi-static background features 154_{S1}, 154_{S2}, 154_{S3}, 154_{S4} and into a plurality of dynamic image features 160 that includes dynamic image features 154_{D1}, 154_{D2}, 154_{D3}, 154_{D4}, as diagrammatically shown in FIG. 3. Decomposition module 124 may employ various methods to decompose an image frame into dynamic objects and the quasi-static background, some of which include image segmentation techniques (foreground-background segmentation), feature extraction techniques, silhouette extraction techniques, and the like. The decomposition processes may leave quasi-static background 158 with a plurality of empty image segments 162₁, 162₂, 162₃, 162₄ that represents the respective former positions that were assumed by dynamic image features 154_{D1}, 154_{D2}, 154_{D3}, 154_{D4} in each image frame prior to decomposition. In such cases, server image processing unit 116 is operative to perform background completion, which completes or fills the empty image segments with suitable quasi-static background texture, as denoted by 164 (FIG. 3).

Following decomposition, decomposition module 124 generates and outputs data pertaining to decomposed plurality of dynamic image features 160 to object tracking module 128. Object tracking module receives setting metadata 140 as well as data of decomposed plurality of dynamic image features 160 outputted from decomposition module 124 (and decomposition metadata). Object tracking module 128 differentiates between different dynamic image features 154 by analyzing the spatial and temporal attributes of each of dynamic image features 154_{D1}, 154_{D2}, 154_{D3}, 154_{D4}, for each k-th image frame 122^{k}ᵢ, such as relative movement, and change in position and configuration with respect to at least one subsequent image frame (e.g., 122^{k}ᵢ₊₁, 122^{k}ᵢ₊₂, etc.). For this purpose, each object may be assigned a motion vector (not shown) corresponding to the direction of motion and velocity magnitude of that object with in relation to successive image frames. Techniques such as frame differencing (i.e., using differences between successive frames), correlation-based tracking methods (e.g., utilizing block matching methods), optical flow techniques (e.g., utilizing the principles of a vector field, the Lucas-Kanade method, etc.), feature-based methods, and the like, may be employed. Object tracking module 128 is thus operative to independently track different objects represented by dynamic image features 154_{D1}, 154_{D2}, 154_{D3}, 154_{D4} according to their respective spatial attributes (e.g., positions) in successive image frames. Object tracking module 128 generates and outputs data pertaining to plurality of tracked objects to object recognition module 130.

Object recognition module 130 receives setting metadata 140 from memory 118 and data pertaining to plurality of tracked objects (from object tracking module 128) and is operative to find and to label (e.g., identify) objects in the video streams based on at least one or more object characteristics. An object characteristic is an attribute that can be used to define or identify the object, such as an object model. Object models may be known a priori, such as by comparing detected object characteristics to a database of object models. Alternatively, objects models may not be known a priori, in which case object recognition module 130 may use, for example, genetic algorithm techniques for recognizing objects in the video stream. For example, in the case of known object models, a walking human object model would characterize the salient attributes that would define it (e.g., use of a motion model with respect to its various parts (legs, hands, body motion, etc.)). Another example would be recognizing, in a video stream, players of two opposing teams on a playing field/pitch, where each team has its distinctive apparel (e.g., color, pattern) and furthermore, each player is numbered. The task of object recognition module 130 would be to find and identify each player in the video stream. FIG. 3 illustrates a plurality of tracked and recognized objects 166 that are labeled 168₁, 168₂, 168₃, and 168₄. Hence, there is a one-to-one correspondence between dynamic image features 154_{D1}, 154_{D2}, 154_{D3}, 154_{D4} and their respective tracked and recognized objects labels. Specifically, dynamic image feature 154_{D1} is tracked and recognized (labeled) as object 168₁, and likewise, dynamic image feature 154_{D2} is tracked and recognized as object 168₂, dynamic image feature 154_{D3} is tracked and recognized as object 168₃, and dynamic image feature 154_{D4} is tracked and recognized as object 168₄ at all instances of each of their respective appearances in video stream 122^{k}. This step is likewise performed substantially in real-time for all video streams 122¹, 122², . . . , 122^{N}. Object recognition module 130 may utilize one or more of the following principles: object and/or model representation techniques, feature detection and extraction techniques, feature-model matching and comparing techniques, heuristic hypothesis formation and verification (testing) techniques, etc. Object recognition module 130 generates and outputs substantially in real-time data pertaining to plurality of tracked and recognized objects to formatting module 130. In particular, object recognition module conveys information pertaining to the one-to-one correspondence between dynamic image features 154_{D1}, 154_{D2}, 154_{D3}, 154_{D4} and their respective identified (labeled) objects 168₁, 168₂, 168₃, and 168₄.

Formatting module 132 receives (i.e., from object recognition module 130) data pertaining to plurality of continuously tracked and recognized objects and is operative to format these tracked and recognized objects into a sequence of miniaturized image frames 170. Sequence of miniaturized image frames 170 includes a plurality of miniature image frames 172₁, 172₂, 172₃, 172₅, . . . , 172_{O} (where index O represents a positive integer) shown in FIG. 3 arranged in matrix form 174 (that may be herein collectively referred as a “mosaic image”). Each miniature image frame is basically a cell that contains a miniature image of a respective recognized object from plurality of dynamic image features 160. In other words, a miniature image frame is an extracted portion (e.g., a group of pixels, a “silhouette”) of full sized i-th image frame 122^{k}ᵢ containing an image of a respective recognized object minus quasi-static background 152. Specifically, miniature image frame 172₁ contains an image of tracked and recognized object 168₁, miniature image frame 172₂ contains an image of tracked and recognized object 168₂, miniature image frame 172₃ contains an image of tracked and recognized object 168₃, and miniature image frame 172₄ contains an image of tracked and recognized object 168₄. Miniature image frames 172₁, 172₂, 172₃, 172₅, . . . , 172_{O} are represented simplistically in FIG. 3 to be rectangular-shaped for the purpose of elucidating the disclosed technique, however, other frame shapes may be applicable (e.g., hexagons, squares, various undefined shapes, and the like). In general, the formatting process performed by formatting module 132 takes into account at least a part of or modification to setting metadata 140 that is passed on from object tracking module 128 and object recognition module 130.

Formatting module 132 is operative to format sequence of miniaturized image frames 170 such to reduce inter-frame movement of the objects in the sequence of miniaturized image frames. The inter-frame movement or motion of a dynamic object within its respective miniature image frame is reduced by optimizing the position of that object such that the majority of the pixels that constitute the object are positioned at substantially the same position within and in relation to the boundary of the miniature image frame. For example, the silhouette of tracked and identified object 168₁ (i.e., the extracted group of pixels representing an object) is positioned such within miniature image frame 172₁ so as to reduce its motion in relation to the boundary of miniaturized image frame 172₁. The arrangement or order of the miniature images of the tracked and recognized objects within sequence of miniaturized image frames 170, represented as matrix 174 is maintained from frame to frame. Particularly, tracked and identified object 168₁ maintains its position in matrix 174 (i.e., row-wise and column-wise) from frame 122^{k}ᵢ to subsequent frames, and in similar manner regarding other tracked and identified objects.

Formatting module 132 is further operative to reduce (in real-time) high spatial frequency data in sequence of miniaturized image frames 170. In general, the spatial frequency may be defined as the number of cycles of change in digital number values (e.g., bits) of an image per unit distance (e.g., 5 cycles per millimeter) along a specific direction. In essence, high spatial frequency data in sequence of miniaturized image frames 170 is reduced such to decrease the information content thereof, substantially without degrading perceptible visual quality (e.g., for a human observer) of the dynamic image features. The diminution of high spatial frequency data is typically implemented for reducing psychovisual redundancies associated with the human visual system (HVS). Formatting module 132 may employ various methods for limiting or reducing high spatial frequency data, such as the utilization of lowpass filters, a plurality of bandpass filters, convolution filtering techniques, and the like. In accordance with one implementation of the disclosed technique, the miniature image frames are sized in blocks that are multiples of 16×16 pixels, in which dummy-pixels may be included therein so as to improve compression efficiency (and encoding) and to reduce unnecessary high spatial frequency content. Alternatively, the dimensions of miniature image frames may take on other values, such as multiples of 8×8 blocks, 4×4 blocks, 4×2/2×4 blocks, etc. In addition, since each of the dynamic objects that appear in the video stream are tracked and identified, the likelihood of multiplicities occurring, manifesting in the multiple appearances of the same identified dynamic object, may be reduced (or even totally removed) thereby reducing the presence of redundant content in the video stream.

Formatting module 132 generates and outputs two distinct data types. The first data type is data of sequence of miniaturized image frames 170 (denoted by 138^{k}, also referred interchangeably hereinafter as “formatted payload data”, “formatted data layer”, or simply “formatted data”), which is communicated to data compressor 134. The second data type is metadata of sequence of miniaturized image frames 170 (denoted by 142^{k}, also referred hereinafter as the “metadata layer”, or “formatting metadata”) that is communicated to data encoder 136. Particularly, the metadata that is outputted by formatting module 132 is an amalgamation of formatting metadata, decomposition metadata yielded from the decomposition process (via decomposition module 124), and metadata relating to object tracking (via object tracking module 128) and object recognition (via object recognition module 130) pertaining to the plurality of tracked and recognized objects. This amalgamation of metadata is herein referred to as “consolidated formatting metadata”, which is outputted by formatting module in metadata layer 142^{k}. Metadata layer 142^{k} includes information that describes, specifies or defines the contents and context of the formatted data. Examples of the metadata layer include the internal arrangement of sequence of miniaturized image frames 170, one-to-one correspondence data (“mapping data”) that associates a particular tracked and identified object with its position in the sequence or position (coordinates) in matrix 174. For example, tracked and identified object 168₃ is within miniature image frame 172₃ and is located at the first column and second row of matrix 174 (FIG. 3). Other metadata may include specification to the geometry (e.g., shapes, configurations, dimensions) of the miniature image frames, data specifying the reduction to high spatial frequencies, and the like.

Data compressor 134 compresses the formatted data received from formatting module 132 according to video compression (coding) principles formats and standards. Particularly, data compressor 132 compresses the formatted data corresponding to sequence of miniaturized image frames 170 and outputs a dynamic data layer 144^{k} (per k-th video stream) that is communicated to data encoder 136. Data compressor 134 may employ, for example, the following video compression formats/standards: H.265, VC-2, H.264 (MPEG-4 Part 10), MPEG-4 Part 2, H.263, H.262 (MPEG-2 Part 2), and the like. Video compression standard H.265 is preferable since is supports video resolutions of 8K.

Data compressor 126 receives the quasi-static background data from decomposition module 124 and compresses this data thereby generating an output quasi-static data layer 146^{k} (per video stream k) that is conveyed to data encoder 136. The main difference between data compressor 126 and data compressor 134 is that the former is operative and optimized to compress slow-changing quasi-static background data whereas the latter is operative and optimized to compress fast-changing (formatted) dynamic feature image data. The terms “slow-changing” and “fast-changing” are relative terms that are to be assessed or quantified relative to the reference time scale, such as the frame rate of the video stream. Data compressor 126 may employ the following video compression formats/standards: H.265, VC-2, H.264 (MPEG-4 Part 10), MPEG-4 Part 2, H.263, H.262 (MPEG-2 Part 2), as well as older formats/standards such as MPEG-1 Part 2, H.261, and the like. Alternatively, both data compressor 126 and 134 are implemented in a single entity (block—not shown).

Data encoder 136 receives quasi-static data layer 146k from data compressor 126, dynamic data layer 144^{k} from data compressor 134, and metadata layer 142^{k} from formatting module 132 and encodes each one of these to generate respectively, an encoded quasi-static data layer output 148^{k}, an encoded dynamic data layer output 150k, and an encoded metadata layer output 152^{k}. Data encoder 136 employs variable bitrate (VBR) encoding. Alternatively, other encoding methods may be employed such as average bitrate (ABR) encoding, and the like. Data encoder 136 conveys encoded quasi-static data layer output 148^{k}, encoded dynamic data layer output 150^{k}, and encoded metadata layer output 152^{k} to communication unit 112 (FIG. 1), which in turn transmits these data layers to clients 108₁, . . . , 108_{M} via communication medium 120.

The various constituents of image processing unit 116 as shown in FIG. 2 is presented diagrammatically in a form advantageous for elucidating the disclosed technique, however, its realization may be implemented in several ways such as in hardware as a single unit or as multiple discrete elements (e.g., a processor, multiple processors), in firmware, in software (e.g., code, algorithms), in combinations thereof, etc.

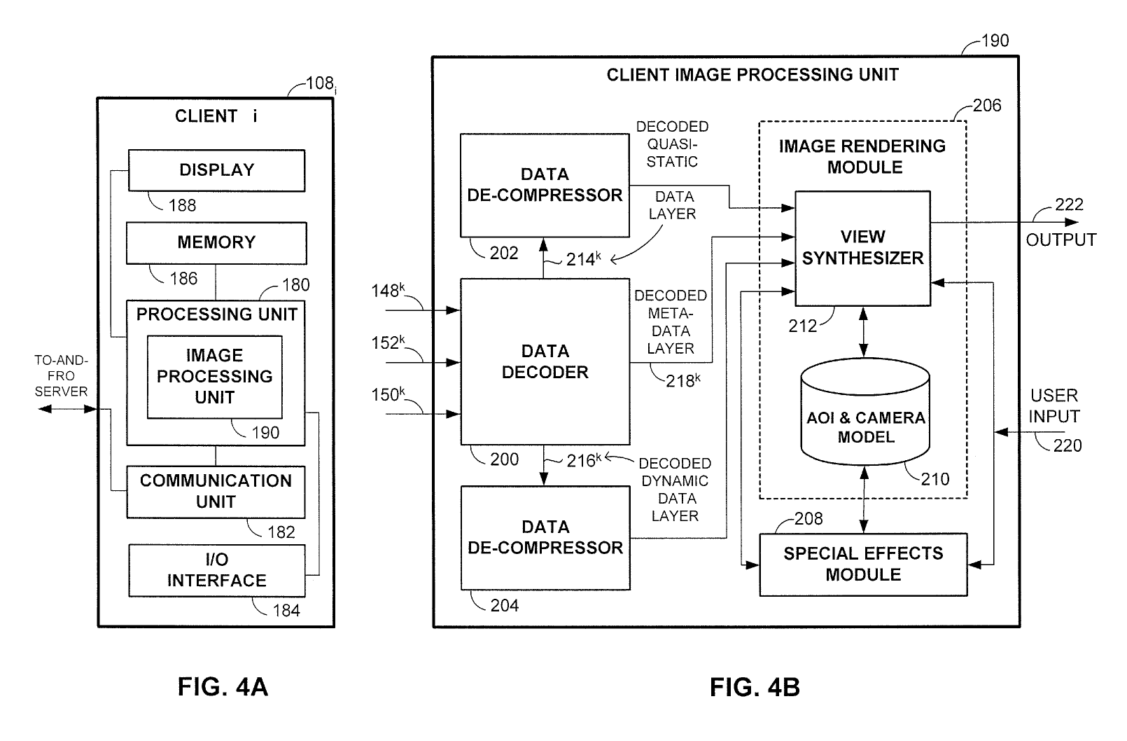

Reference is now further made to FIGS. 4A and 4B. FIG. 4A is a schematic diagram of a general client configuration that is constructed and operative in accordance with the embodiment of the disclosed technique. FIG. 4B is a schematic diagram detailing a client image processing unit of the general client configuration of FIG. 4A, constructed and operative in accordance with the disclosed technique. FIG. 4A illustrates a general configuration of an i-th client 108ᵢ that is selected, without loss of generality, from clients 108₁, 108₂, . . . , 108_{M} (FIG. 1). With reference to FIG. 4A, client 108; includes a client processing unit 180, a communication unit 182, an I/O interface 184, a memory device 186, and a display 188. Client processing unit 180 includes an image processing unit 190. Client processing unit 180 is coupled with communication unit 182, I/O interface 184, memory 186 and display 188. Communication unit 182 of client 108ᵢ is coupled with communication unit 122 (FIG. 1) of server 104 via communication medium 120.

With reference to FIG. 4B, client image processing unit 190 includes a data decoder 200, a data de-compressor 202, a data de-compressor 204, an image rendering module 206, and a special effects module 208. Image rendering module 206 includes an AOI & camera model section 210 and a view synthesizer section 212 that are coupled with each other. Data decoder 200 is coupled with data de-compressor 202, data de-compressor 204, and view synthesizer 212. Data de-compressor 202, data de-compressor 204, and special effects module 208 are each individually and independently coupled with data view synthesizer 212 of image rendering module 206.

Client communication unit 182 (FIG. 4A) receives encoded quasi-static data layer output 148^{k}, encoded dynamic data layer output 150^{k}, and encoded metadata layer output 152^{k} communicated from server communication unit 112. Data decoder (FIG. 4B) receives as input, encoded quasi-static data layer output 148^{k}, encoded dynamic data layer output 150^{k}, and encoded metadata layer output 152^{k} outputted from client communication unit 182 and respectively decodes this data and metadata in a reverse procedure to that of data encoder 136 (FIG. 2) so as to generate respective decoded quasi-static data layer 214^{k} (for the k-th video stream), decoded dynamic data layer 216^{k}, and decoded metadata layer 218^{k}. Decoded quasi-static data layer 214^{k}, decoded dynamic data layer 216^{k}, and decoded metadata layer 218^{k} are also herein denoted respectively simply as “quasi-static data layer 214”, “dynamic data layer 216”, and “metadata layer 218” as the originally encoded data and metadata is retrieved after the decoding process of data decoder 200. Data decoder 200 conveys the decoded quasi-static data layer 214^{k} to de-compressor 202, which in turn de-compresses quasi-static data layer 214^{k} in a substantially reverse complementary data compression procedure that was carried out by data compressor 126 (FIG. 2), thereby generating and outputting de-compressed and decoded quasi-static data layer 214^{k} to view synthesizer 212. Analogously, data decoder 200 conveys the decoded dynamic data layer 216^{k} to de-compressor 204, which in turn de-compresses dynamic data layer 216^{k} in a substantially reverse complementary data compression procedure that was carried out by data compressor 134 (FIG. 2), thereby generating and outputting de-compressed and decoded dynamic data layer 216^{k} to view synthesizer 212. Data decoder 200 outputs decoded metadata layer 218^{k} to view synthesizer 212.

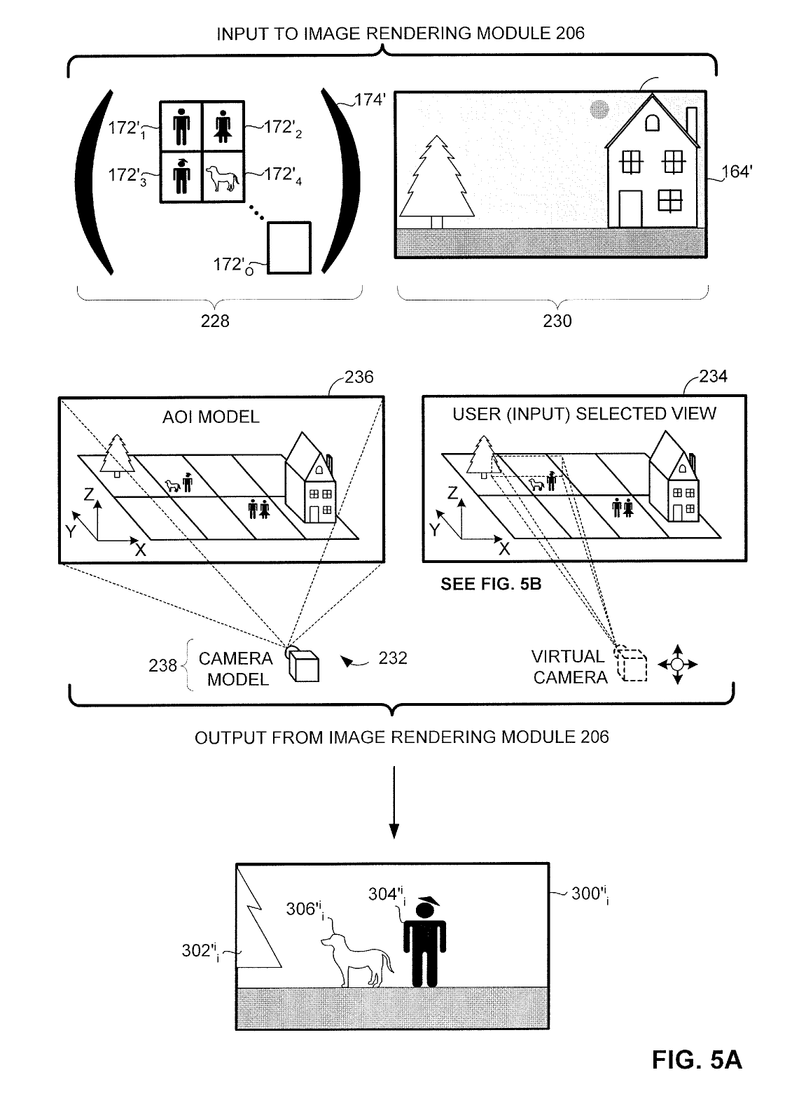

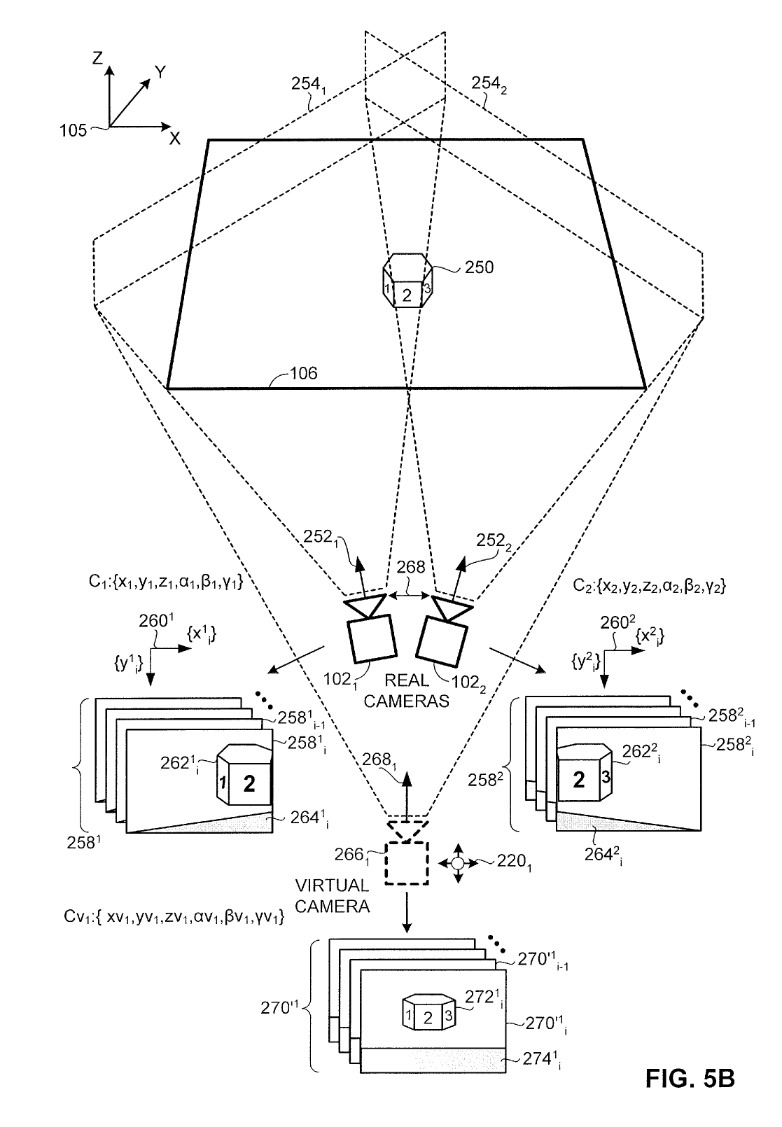

Reference is now further made to FIGS. 5A and 5B. FIG. 5A is a schematic diagram representatively illustrating implementation of image processing procedures at by the client image processing unit of FIG. 4B, in accordance with the principles of the disclosed technique. FIG. 5B is a schematic diagram illustrating a detailed view of the implementation of image processing procedures of FIG. 5A specifically relating to the aspect of a virtual camera configuration, in accordance with the embodiment of the disclosed technique. The top portion of FIG. 5A illustrates what is given as an input to image rendering module 206 (FIG. 4), whereas the bottom portion of FIG. 5A illustrates one of the possible outputs from image rendering module 206. As shown in FIG. 5A, there are four main inputs to image rendering module 206, which are dynamic data 228 (including matrix 174′ and corresponding metadata), quasi-static data 230 (including quasi-static background 164′), basic settings data 232, and user selected view data 234.

Generally, in accordance with a naming convention used herein, unprimed reference numbers (e.g., 174) indicate entities at the server side, whereas matching primed (174′) reference numbers indicate corresponding entities at the client side. Hence, data pertaining to matrix 174′ (received at the client side) is substantially identical to data pertaining to matrix 174 (transmitted from the server side). Consequently, matrix 174′ (FIG. 5A) includes a plurality of (decoded and de-compressed) miniature image frames 172′₁, 172′₂, 172′₃, 172′₅, . . . , 172′_{O} substantially identical with respective miniature image frames 172₁, 172₂, 172₃, 172₅, . . . , 172_{O}. Quasi-static image 164′, which relates to quasi-static data 230, is substantially identical with quasi-static image 164 (FIG. 3).

Basic settings data 232 includes an AOI model 236 and a camera model 238 that are stored and maintained by AOI & camera model section 210 (FIG. 4B) of image rendering module 206. AOI model 236 defines the spatial characteristics of the imaged scene of interest (AOI 106) in a global coordinate system (105). Such spatial characteristics may include basic properties such as the 3-D geometry of the imaged scene (e.g., length, width, height dimensions, ground topology, and the like). Camera model 238 is set of data (e.g., a mathematical model) that defines for each camera 102₁, . . . 102_{N} extrinsic data that includes its physical position and orientation (C₁, . . . , C_{N}) with respect to global coordinate system 105, as well as intrinsic data that includes the camera and lens parameters (e.g., focal length(s), aperture values, shutter speed values, FOV, optical center, optical distortions, lens transmission ratio, camera sensor effective resolution, aspect ratio, dynamic range, signal-to-noise ratio, color depth data, etc.).

Basic settings data 232 is typically acquired in an initial phase, prior to operation of system 100. Such an initial phase usually includes a calibration procedure, whereby ultra-high resolution cameras 102₁, 102₂, . . . , 102_{N} are calibrated with each other and with AOI 106 so as to enable utilization of photogrammetry techniques to allow translation between the positions of objects captured in an image space with the 3-D coordinates with objects in the a global (“real-world”) coordinate system 105. The photogrammetry techniques are used to generate a transformation (a mapping) that associates pixels in an image space of a captured image frame of a scene with corresponding real-world global coordinates of the scene. Hence, a one-to-one transformation (a mapping) that associates points in a two-dimensional (2-D) image coordinate system and a 3-D global coordinate system (and vice versa). A mapping from a 3-D global coordinate system (real-world) to a 2-D image space coordinate system is also known as a projection function. Conversely, a mapping from a 2-D image space coordinate system to a 3-D global coordinate system is also known as a back-projection function. Generally, for each pixel in a captured image 122^{k}ᵢ (FIG. 3, of a scene, e.g., AOI 106) having 2-D coordinates {x^{k}ᵢ,y^{k}ᵢ} in the image space there exists a corresponding point in the 3-D global coordinate system 105 {X,Y,Z} (and vice versa). Furthermore, during this initial calibration phase, the internal clock (not shown) kept by the plurality of ultra-high resolution cameras are all set to a reference time (clock).

User selected view data 234 involves a “virtual camera” functionality that involves the creation of rendered (“synthetic”) video images, such that a user (end-user, administrator, etc.) of the system may select to view the AOI from a particular viewpoint that is not a constrained viewpoint of one of stationary ultra-high resolution cameras. The creation of a synthetic virtual camera image may involve utilization of image data that is acquired simultaneously from a plurality of the ultra-high resolution cameras. A virtual camera is based on calculations of a mathematical model that describes and determines how objects in a scene are to be rendered depending on specified input target parameters (a “user selected view”) of the virtual camera (e.g., the virtual camera (virtual) position, (virtual) orientation, (virtual) angle of view, and the like).

Image rendering module 206 is operative to render an output, based at least in part on user selected view 234, described in detail in conjunction with FIG. 5B. FIG. 5B illustrates AOI 106 having a defined perimeter and area that includes an object 250 that is being imaged, for simplicity, by two ultra-high resolution cameras 102₁, 102₂ arranged in duo configuration (pair) separated by an intra-lens distance 240. Each ultra-high resolution camera 102₁, 102₂ has its respective constrained viewpoint, defined by a look (view, staring) vector 252₁, 252₂ (respectively), as well as its respective position and orientation C₁:{x₁,y₁,z₁,α₁,β₁,γ₁}, C₂:{x₂,y₂,z₂,α₂,β₂,γ₂} in global coordinate system 105. Each one of ultra-high resolution cameras 102₁ and 102₂ has its respective view volume (that may generally be conical) simplistically illustrated by respective frustums 254₁, and 254₂. Ultra-high resolution cameras 102₁ and 102₂ are statically positioned and oriented within global coordinate system 105 so as to capture video streams of AOI 106, each at respectively different viewpoints, as indicated respectively by frustums 254₁ and 254₂. In general, a frustum represents an approximation to the view volume, usually determined by the optical (e.g., lens), electronic (e.g., sensor) and mechanical (e.g., lens-to-sensor coupling) properties of the respective ultra-high resolution camera.

FIG. 5B illustrates that ultra-high resolution camera 102₁ captures a video stream 258¹ that includes a plurality of image frames 258¹₁, . . . , 258¹; of AOI 106 that includes object 250 from a viewpoint indicated by view vector 252₁. Image frames 258¹₁, . . . , 258¹ᵢ are associated with an image space denoted by image space coordinate system 260¹. Image frame 258′¹ᵢ shows an image representation 262¹ᵢ of (foreground, dynamic) object 250 as well as a representation of (quasi-static) background 264²ᵢ as captured by ultra-high resolution camera 102₁ from its viewpoint. Similarly, ultra-high resolution camera 102₂ captures a video stream 258² that includes a plurality of image frames 258²₁, . . . , 258²ᵢ of AOI 106 that includes object 250 from a viewpoint indicated by view vector 252₂. Image frames 258²₁, . . . , 258²ᵢ are also associated with an image space denoted by image space coordinate system 260². Image frame 258²ᵢ shows an image representation 262²ᵢ of (foreground, dynamic) object 250 as well as a representation of (quasi-static) background 264²ᵢ as captured by ultra-high resolution camera 102₂ from its viewpoint, and so forth likewise for ultra-high resolution camera 102_{N} (not shown).

Video streams 258¹ and 258² (FIG. 5B) are processed in the same manner by system 100 as described hereinabove with regard to video streams 122¹ and 122² (through 122^{N}) according to the description brought forth in conjunction with FIGS. 1 through 4B, so as to generate respective decoded reconstructed video streams 258′¹, 258′², . . . , 258′^{N} (not shown). View synthesizer 212 receives video streams 258′¹, 258′² (decomposed into quasi-static data 230, dynamic data 228 including metadata) as well as user input 220 (FIG. 4B) that specifies a user-selected view of AOI 106. The user selection may be inputted by client I/O interface 184 (FIG. 4A) such as a mouse, keyboard, touchscreen, voice-activation, gesture recognition, electronic pen, haptic feedback device, gaze input device, and the like. Alternatively, display 188 may function as an I/O device (e.g., touchscreen) thereby receiving user input commands and outputting corresponding information related to the user's selection.

View synthesizer 212 is operative to synthesize a user selected view 234 of AOI 106 in response to user input 220. With reference to FIG. 5B, suppose user input 220 details a user selected view of AOI 106 that is represented by virtual camera 266₁ having a user selected view vector 268₁ and a virtual view volume (not specifically shown). The virtual position and orientation of virtual camera 266₁ in global coordinate system 105 is represented by the parameters denoted by Cv₁:{xv₁,yv₁,zv₁,αv₁,βv₁,γv₁} (where the letter suffix ‘v’ indicates a virtual camera as opposed to real camera). User input 220 (FIG. 4B) is represented in FIG. 5B for virtual camera 266₁ by the crossed double-edge arrows symbol 220₁ indicating that the position, orientation (e.g., yaw, pitch, roll) as well as other parameters (e.g., zoom, aperture, aspect ratio) may be specified and selected by user input. For the sake of simplicity and conciseness only one virtual camera is shown in FIG. 5B, however, the principles of the disclosed technique shown herein equally apply to a plurality of simultaneous instances of virtual cameras (e.g., 262₂, 262₃, 262₄, etc.—not shown), per user.

Decoded (and de-compressed) video streams 258′¹ and 258′² (i.e., respectively corresponding to captured video streams 258¹ and 258² shown in FIG. 5B) are inputted to view synthesizer 212 (FIG. 4B). Concurrently, user input 220 that specifies a user-selected view 234 (FIG. 5A) of AOI 106 is input to view synthesizer 212. View synthesizer 212 processes video streams 258′¹ and 258′² and input 220, taking account of basic settings data 232 (AOI model 236 and camera model 238) so as to render and generate a rendered output video stream that includes a plurality of image frames. FIG. 5B illustrates for example, a rendered video stream 270′¹ (FIG. 5B) that includes a plurality of rendered image frames 270′¹₁ (not shown), . . . , 270′¹ᵢ₋₁, 270′¹ᵢ. For a particular i-th image frame in time, view synthesizer 212 takes any combination of i-th image frames that are simultaneously captured by the ultra-high resolution cameras and renders information contained therein so as to yield a rendered “synthetic” image of the user-selected view of AOI 106, as will be described in greater detail below along with the rendering process. For example, FIG. 5B illustrates a user selected view for virtual camera 266₁, at least partially defined by the position and orientation parameters Cv₁:{xv₁,yv₁,zv₁,αv₁,βv₁,γv₁}, viewing vector 268₁, and virtual camera view volume (not shown). Based on user input 220 for a user-selected view 234 of AOI 106, view synthesizer 212 takes for the i-th simultaneously captured image frame 258¹ᵢ captured by ultra-high resolution camera 102₁ and image frame 258²ᵢ captured by ultra-high resolution camera 102₂ and renders in real-time information contained therein so as to yield a rendered “synthetic” image 270′¹ᵢ. This operation is performed in real-time for each of the i-th simultaneously captured image frames, as defined by user input 220. The simultaneity of captured image frames from different ultra-high resolution cameras may be ensured by the respective timestamps (not shown) of the cameras that are calibrated to a global reference time during the initial calibration phase. Specifically, rendered image frame 270′¹ᵢ includes a rendered (foreground, dynamic) object 272′¹ᵢ that is a representation of object 250 as well as rendered (quasi-static) background 274′¹ᵢ that is a representation of the background (not shown) of AOI 106, from a virtual camera viewpoint defined by virtual camera 266₁ parameters.

The rendering process performed by image rendering module 206 typically involves the following steps. Initially, the mappings (correspondences) between the physical 3-D coordinate systems of each ultra-high resolution camera with the global coordinate system 105 are known. Particularly, AOI model 236 and camera model 238 are known and stored in AOI & camera model section 212. In general, the first step of the rendering process involves construction of back-projection functions that respectively map the image spaces of each image frame generated by a specific ultra-high resolution camera onto 3-D global coordinate system 105 (taking account each respective camera coordinate system). Particularly, image rendering module 206 constructs a back-projection function for quasi-static data 230 such that for each pixel in quasi-static image 164′ there exists a corresponding point in 3-D global coordinate system 105 of AOI model 236. Likewise, for each of dynamic data 228 represented by miniature image frames 172′₁, 172′₂, 172′₃, 172′₅, . . . , 172′_{O} of matrix 174′ there exists a corresponding point in 3-D global coordinate system 105 of AOI model 236. Next, given a user selected view 234 for a virtual camera (FIG. 5B), each back-projection function associated with a respective ultra-high resolution camera is individually mapped (transformed) onto the coordinate system of virtual camera 266₁ (FIG. 5B) so as to create a set of 3-D data points (not shown). These 3-D data points are then projected by utilizing a virtual camera projection function onto a 2-D surface thereby creating rendered image frame 300′ⁱᵢ that is the output of image rendering module 206 (FIG. 5A). The virtual camera projection function is generated by image rendering module 206. Rendered image frame 300′ⁱᵢ is essentially an image of the user selected view 234 of a particular viewpoint of imaged AOI 106, such that this image includes a representation of at least part of quasi-static background data 230 (i.e., image feature 302′ⁱᵢ corresponding quasi-static object 154_{S3} shown in FIG. 3) as well as a representation of at least part of dynamic image data 228 (i.e., image features 304′ⁱᵢ and 306′ⁱᵢ, which respectively correspond to objects 154_{D3} and 154_{D4} in FIG. 3).

FIG. 5B shows that image frames 258¹ᵢ and 258²ᵢ generated respectively by two ultra-high resolution cameras 102₁ and 102₂ are rendered by image rendering module 206, by taking into account user selected view 234 for virtual camera 266₁ so as to generate a corresponding rendered image frame 270′¹ᵢ that typically includes data from the originally captured image frames 258¹ᵢ and 258²ᵢ. Basically, each pixel in rendered image frame 270′¹ᵢ corresponds to either a pixel in frame 258¹ᵢ (or some variation thereof) that is captured by ultra-high resolution camera 102₁, a pixel in image frame 258²ᵢ (or some variation thereof) that is captured by ultra-high resolution camera 102₂, or a mixture of two pixels thereof. Hence, image rendering module 206 uses image data contained in the simultaneously captured image frames of the ultra-high resolution cameras to model and construct a rendered image from a user-selected viewpoint. Consequently, image features of an imaged object (e.g., FIG. 5B, object 250 in the shape of a hexagonal prism) not captured by a particular ultra-high resolution camera (e.g., 102₁) in a particular look vector 252₁, for example face “3” may be captured by one of the other ultra-high resolution cameras (e.g., 102₂ having a different look vector 252₂). Conversely to the preceding example, image features (i.e., face “1” of the hexagonal prism) of imaged object 250 not captured by ultra-high resolution camera 102₂, may be captured by another one of the ultra-high resolution cameras (i.e., 102₁). A user selected virtual camera viewpoint (at least partly defined by virtual camera look vector 268₁) may combine the image data captured from two or more ultra-high resolution cameras having differing look vectors so as to generate a rendered “synthetic” image containing, at least partially, a fusion of the image data (e.g., faces “1”, “2”, “3” of imaged object 250).

User input 220 for a specific user-selected view of a virtual camera may be limited in time (i.e., to a specified number image frames), as the user may choose to delete or inactivate a specific virtual camera and activate or request another different virtual camera. FIG. 5B demonstrates the creation of a user-selected view image from two real ultra-high resolution cameras 102₁ and 102₂, however, the disclosed technique is also applicable in the case where a user-selected viewpoint (virtual camera) is created using a single (real) ultra-high resolution camera (i.e., one of cameras 102₁, 102₂, . . . , 102_{N}), such as in the case of a zoomed view (i.e., narrowed field of view (FOV)) of a particular part of AOI 106.

View synthesizer 212 outputs data 222 (FIG. 4B) pertaining to rendered image frame 300′ⁱᵢ to display device 188 (FIG. 4A) of the client. Although FIG. 5A illustrates that a single i-th image frame 300′ⁱᵢ is outputted from image rendering module 206, for the purposes of simplifying the description of the disclosed technique, the outputted data is in fact in the form of a video stream that includes a plurality of successive image frames (e.g., as shown by rendered video stream 270′¹ in FIG. 5B). Alternatively, display device 188 is operative to simultaneously display image frames of a plurality of video streams rendered from different virtual cameras (e.g., via a “split-screen” mode, a picture-in-picture (PiP) mode, etc.). Other combinations are viable. Client processing unit 180 may include a display driver (not shown) that is operative to adapt and calibrate the specifications and characteristics (e.g., resolution, aspect ratio, color model, contrast, etc.) of the displayed contents (image frames) to meet or at least partially accommodate the display specifications of display 188. Alternatively, the display driver is a separate entity (e.g., a graphic processor—not shown) coupled with client processing unit 180 and with display 188. Further alternatively, the display driver is incorporated (not shown) into display 188. At any rate, either one of image rendering module 206 or processing unit 180 is operative to apply to outputted data 222 (video streams) a variety of post-processing techniques that are known in the art (e.g., noise reduction, gamma correction, etc.).

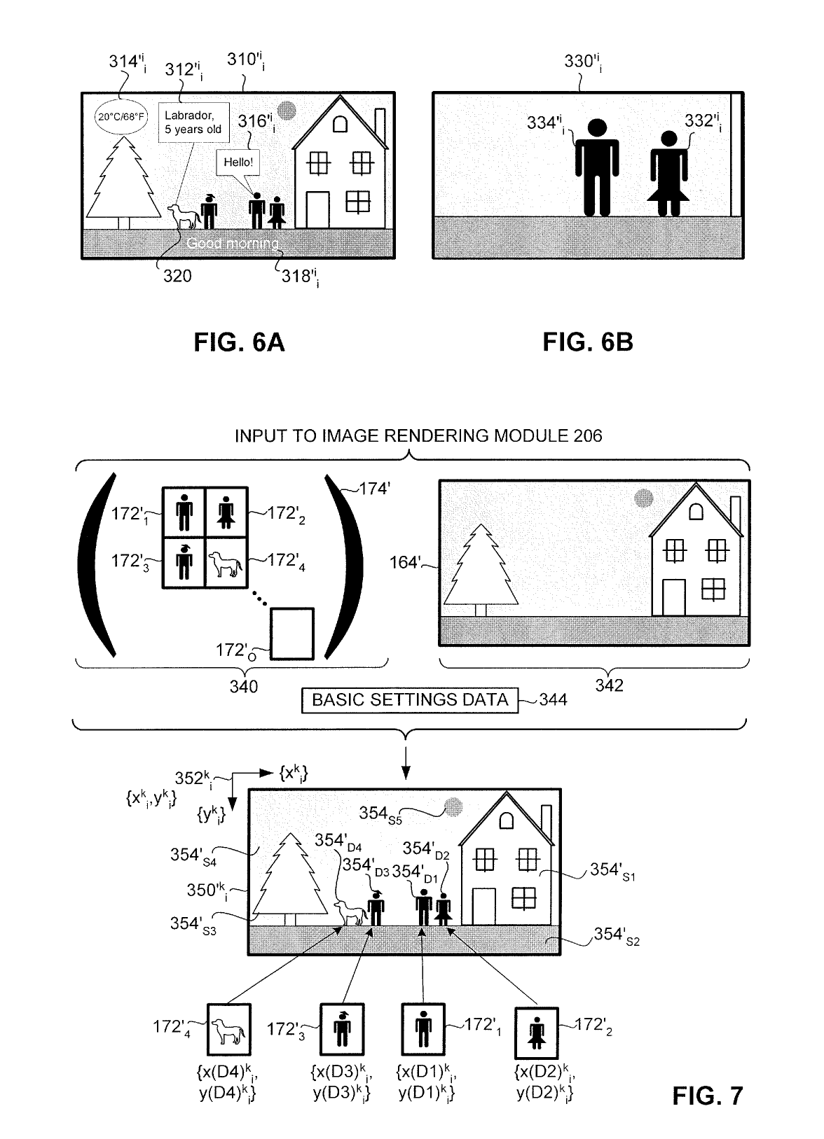

In addition to the facility of providing a user-selected view (virtual camera ability), system 100 is further operative to provide the administrator of the system as well as to plurality of clients 108₁, 108₂, . . . , 108_{M} (end-users) with capability of user-to-system interactivity including the capability to select from a variety of viewing modes of AOI 106. System 100 is further operative to superimpose on, or incorporate into the viewed images data and special effects (e.g., graphics content that includes text, graphics, color changing effects, highlighting effects, and the like). Example viewing modes include a zoomed view (i.e, zoom-in, zoom-out) functionality, an object tracking mode (i.e., where the movement of a particular object in the video stream is tracked), and the like. Reference is now further made to FIGS. 6A and 6B. FIG. 6A is a schematic diagram illustrating incorporation of special effects and user-requested data into an outputted image frame of a video stream, constructed and operative in accordance with the embodiment of the disclosed technique. FIG. 6B is a schematic diagram illustrating an outputted image of a video stream in a particular viewing mode, constructed and operative in accordance with the embodiment of the disclosed technique. FIG. 6A illustrates an outputted i-th image frame 310′ⁱᵢ in an i-th video stream that is outputted to the i-th client, one of M clients 108₁, 108₂, . . . , 108_{M} (recalling that T represents a general running index). Image frame 310′ⁱᵢ includes a plurality of objects as previously shown, as well as a plurality of graphically integrated (e.g., superimposed, overlaid, fused) data items 312′ⁱᵢ, 314′ⁱᵢ, 316′ⁱᵢ, and 318′ⁱᵢ (also termed herein as “graphical objects”).

According to one aspect of the user-to-system interaction of the disclosed technique, system 100 facilitates the providing of information pertaining to a particular object that is shown in image frames of the video stream. Particularly, in response to a user request of one of the clients (via user input 220 (FIG. 4B) through I/O interface 184 (FIG. 4A)) to obtain information relating to a particular object 320 (FIG. 6A), a graphical data item 312′ⁱᵢ is created by special effects module 208 (FIG. 4B) and superimposed by image rendering module 206 onto outputted image frame 310′ⁱᵢ. Graphical data item 312′ⁱᵢ includes information (e.g., identity, age, average speed, other attributes, etc.) pertaining to that object 320. An example of a user-to-system interaction involves a graphical user interface (GUI) that allows interactivity between displayed images and user input. For example, a user input may be in the form of a “clickable” image, whereby objects within a displayed image are clickable by a user thereby generating graphical objects to be superimposed on the displayed image. Generally, a variety of graphical and visual special effects may be generated by special effects module 208 and integrated (i.e., via image rendering module 206) into the outputted image frames of the video stream. For example, as shown in FIG. 6A, a temperature graphical item 314′ⁱᵢ is integrated into outputted image frame 310′ⁱᵢ, as well as textual graphical data items 316′ⁱᵢ (conversation) and 318′ⁱᵢ (subtitle), and the like. The disclosed technique allows for different end-users (clients) to interact with system 100 in a distinctive and independent manner in relation to other end-users.

According to another aspect of the user-to-system interaction of the disclosed technique, system 100 facilitates the providing of a variety of different viewing modes to end-users. For example, suppose there is a user request (by an end-user) of a zoomed view of dynamic objects 154_{D1} and 154_{D2} (shown in FIG. 3). To obtain a specific viewing mode of AOI 106, an end-user of one of the clients inputs the user request (via user input 220 (FIG. 4B) through I/O interface 184 (FIG. 4A)) to obtain a specific viewing mode of AOI 106. In general, a zoom viewing mode is where there is a change in the apparent distance or angle of view of an object from an observer (user) with respect to the native FOV of the camera (e.g., fixed viewpoints of ultra-high resolution cameras 102₁, 102₂, . . . , 102_{N}). Owing to the ultra-high resolution of cameras 102₁, 102₂, . . . , 102_{N}, system 100 employs digital zooming methods whereby the apparent angle of view of a portion of an image frame is reduced (i.e., image cropping) without substantially degrading (humanly) perceptible visual quality of the generated cropped image. In response to a user's request (user input, e.g., detailing the zoom parameters, such as the zoom value, the cropped image portion, etc.), image rendering module 206 (FIG. 4B) renders a zoomed-in (cropped) image output as (i-th) image frame 330′ⁱᵢ, generally for in an i-th video stream outputted to the i-th client (i.e., one of M clients 108₁, 108₂, . . . , 108_{M}). Zoomed image frame 330′ⁱᵢ (FIG. 6B) includes objects 332′ⁱᵢ and 334′ⁱᵢ that are zoomed-in (cropped) image representations of tracked and identified objects 154_{D4} and 154_{D3} (respectively). FIG. 6B shows a combination of a zoomed-in (narrowed FOV) viewing mode together with an object tracking mode, since objects 154_{D3} and 154_{D4} (FIG. 3) are described herein as dynamic objects that have non-negligible (e.g., noticeable) movement in relation to their respective positions in successive image frames of the video stream.

In accordance with another embodiment of the disclosed technique, the user selected view is independent to the functioning of system 100 (i.e., user input for a virtual camera selected view is not necessarily utilized). Such a special case may occur when the imaged scene by one of the ultra-high resolution cameras already coincides with a user selected view, thereby obviating construction of a virtual camera. User input would entail selection of a particular constrained camera viewpoint to view the scene (e.g., AOI 106). Reference is now made to FIG. 7, which is a schematic diagram illustrating a simple special case of image processing procedures excluding aspects related to the virtual camera configuration, constructed and operative in accordance with another embodiment of the disclosed technique. The top portion of FIG. 7 illustrates the given input to image rendering module 206 (FIG. 4), whereas the bottom portion of FIG. 7 illustrates an output from image rendering module 206. As shown in FIG. 5A, there are three main inputs to image rendering module 206, which are dynamic data 340, (including matrix 174′ and corresponding metadata), quasi-static data 342 (including quasi-static background 164′), and basic settings data 344. The decoded metadata (i.e., metadata layer 218^{k}, FIG. 4B) includes data that specifies the position and orientation of each of miniature image frames 172₁, 172₂, 172₃, 172₅, . . . , 172_{O} within in the image space of the respective image frame 122′^{k}ᵢ denoted by the image coordinates {x^{k}ᵢ,y^{k}ᵢ}. Basic settings data 344 includes an AOI model (e.g., AOI model 236, FIG. 5A) and a camera model (e.g., camera model 238, FIG. 5A) that are stored and maintained by AOI & camera model section 210 (FIG. 4B) of image rendering module 206. It is understood that the mappings between the physical 3-D coordinate systems of each ultra-high resolution camera with the global coordinate system 105 are known.

Image rendering module 206 (FIG. 4B) may construct a back-projection function that maps image space 156^{k}ᵢ (FIG. 3) of image frame 122^{k}ᵢ generated by the k-th ultra-high resolution camera 102ₖ onto 3-D global coordinate system 105. Particularly, image rendering module 206 may construct a back-projection function for quasi-static data 342 such that for each pixel in quasi-static image 164′ there exists a corresponding point in 3-D global coordinate system 105 of the AOI model in basic settings data 344. Likewise, for each of dynamic data 340 represented by miniature image frames 172′₁, 172′₂, 172′₃, 172′₅, . . . , 172′_{O} of matrix 174′ there exists a corresponding point in 3-D global coordinate system 105 of the AOI model in basic settings data 344.

Image rendering module 206 (FIG. 4B) outputs an image frame 350′^{k}ᵢ (e.g., a reconstructed image frame), which is substantially identical with original image frame 122^{k}ᵢ. Image frame 350′^{k}₁ includes decoded plurality of dynamic image features 354′_{D1}, 354′D₂, 354′_{D3}, 354′_{D4} (substantially identical to respective original plurality of dynamic image features 154_{D1}, 154_{D2}, 154_{D3}, 154_{D4}) and a quasi-static background that includes a plurality of decoded quasi-static background features 354′_{S1}, 354′_{S2}, 354′_{S3}, 354′_{S4} (substantially identical to original quasi-static background features 154_{S1}, 154_{S2}, 154_{S3}, 154_{S4}). The term “substantially” used herein with regard to the correspondence between unprimed and respective primed entities refers, in terms of their data content, to either their identicalness or alikeness to a degree of differentiation of at least one bit of data.

Specifically, to each (decoded) miniature image frame 172′₁, 172′₂, 172′₃, 172′₄, . . . , 172′_{O} there corresponds metadata (in metadata data layer 218^{k}) that specifies its respective position and orientation within rendered image frame 350′^{k}ᵢ. In particular, for each image frame 122^{k}ᵢ (FIG. 3), the position metadata corresponding to miniature image frame 172′₁, denoted by the coordinates {x(D1)^{k}ᵢ,y(D1)^{k}ᵢ}, specifies the original position in image space {x^{k}ᵢ,y^{k}ᵢ} where miniature image frame 172′₁ is to be mapped relative to image space 352^{k}ᵢ of rendered (reconstructed) image frame 350^{k}ᵢ. Similarly, miniature image frames 172′₂, 172′₃, 172′₄, . . . , 172′_{O}, denoted respectively by the coordinates {x(D2)^{k}ᵢ,y(D2)^{k}ᵢ}, {x(D3)^{k}ᵢ,y(D3)^{k}ᵢ}, {x(D4)^{k}ᵢ,y(D4)^{k}ᵢ}, . . . , {x(DO)^{k}ᵢ,y(DO)^{k}ᵢ}, specify the respective positions in image space {x^{k}ᵢ,y^{k}ᵢ} where they are to be mapped.

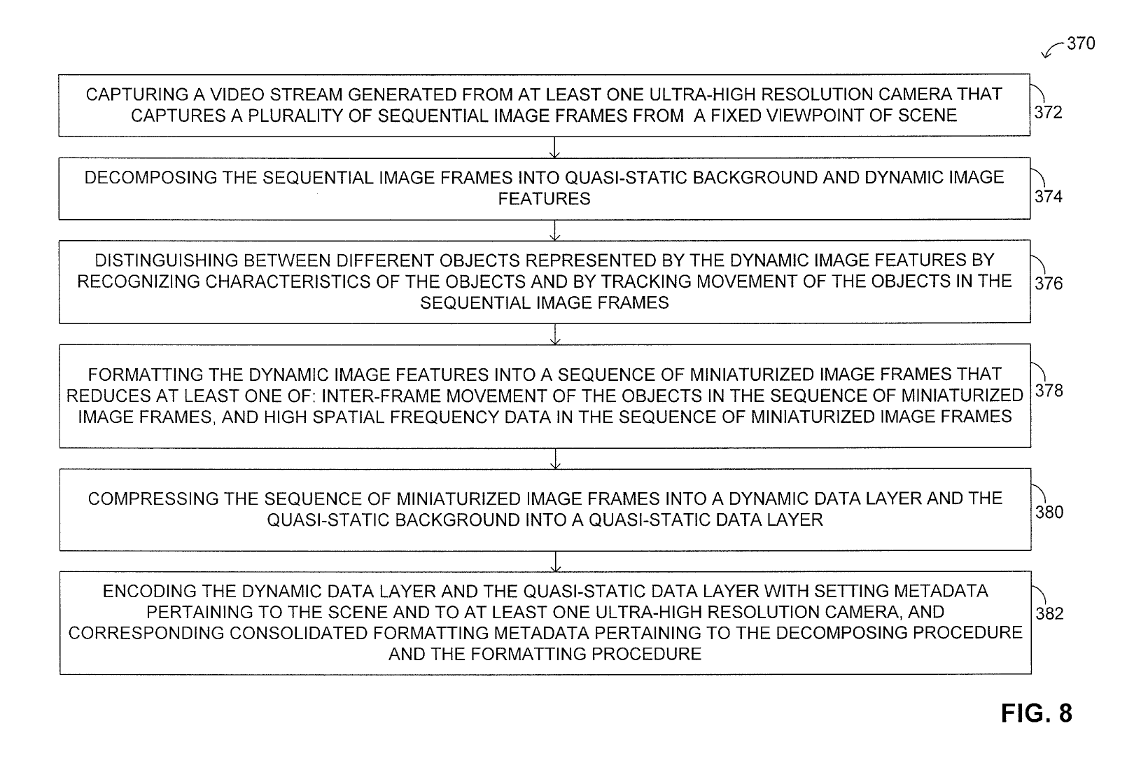

Reference is now made to FIG. 8, which a schematic block diagram of a method, generally referenced 370, for encoding a video stream generated from at least one ultra-high resolution camera capturing a plurality of sequential image frames from a fixed viewpoint of a scene. Method 370 includes the following procedures. In procedure 372, a video stream, generated from at least one ultra-high resolution camera that captures a plurality of sequential image frame from a fixed viewpoint of a scene, is captured. With reference to FIGS. 1 and 3, ultra-high resolution cameras 102₁, 102₂, . . . , 104_{N-1}, 102_{N} (FIG. 1) generate respective video streams ultra-high resolution cameras 122₁, 122₂, . . . , 122_{N-1}, 122_{N} (FIG. 1), from respective fixed viewpoints C1:{x1,y1,z1,α1,β1,γ1}, C1:{x1,y1,z1,α1,β1,γ1}, . . . , C_{N-1}:{x_{N-1},Y_{N-1},z_{N-1},α_{N-1}, β_{N-1},γ_{N-1}}, C_{N}:{x_{N},y_{N},z_{N},α_{N},β_{N},γ_{N}} of AOI 106 (FIG. 1). In general, the k-th video stream 122^{k} (FIG. 3) includes a plurality of L sequential image frames 122^{k}₁, . . . , 122^{k}_{L}.

In procedure 374, the sequential image frames are decomposed into quasi-static background and dynamic image features. With reference to FIGS. 1, 2 and 3, sequential image frames 122^{k}₁, . . . , 122^{k}_{L} (FIG. 3) are decomposed by decomposition module 124 (FIG. 2) of server image processing unit 116 (FIGS. 1 and 2) to quasi-static background 158 (FIG. 3) and plurality of dynamic image features 160 (FIG. 3).

In procedure 376, different objects represented by the dynamic image features are distinguished by recognizing characteristics of the objects and by tracking movement of the objects in the sequential image frames. With reference to FIGS. 2 and 3, object tracking module 128 (FIG. 2) tracks movement 166 (FIG. 3) of different objects represented by dynamic image features 154_{D1}, 154_{D2}, 154_{D3}, 154_{D4} (FIG. 3). Object recognition module 130 (FIG. 2) differentiates between the objects 154_{D1}, 154_{D2}, 154_{D3}, 154_{D4} (FIG. 3) and labels them 168₁, 168₂, 168₃, 168₄ (respectively) (FIG. 3), by recognizing characteristics of those objects 166 (FIG. 3).

In procedure 378, the dynamic image features are formatted into a sequence of miniaturized image frames that reduces at least one of: inter-frame movement of the objects in the sequence of miniaturized image frames, and high spatial frequency data in the sequence of miniaturized image frames. With reference to FIGS. 2 and 3, formatting module 132 (FIG. 2) formats dynamic image features 154_{D1}, 154_{D2}, 154_{D3}, 154_{D4} (FIG. 3) into sequence of miniaturized image frames 170 (e.g., in mosaic or matrix 174 form, FIG. 3) that includes miniaturized image frames 172₁, 172₂, 172₃, 172₄ (FIG. 3). The formatting performed by formatting module 132 reduces inter-frame movement of dynamic objects 154_{D1}, 154_{D2}, 154_{D3}, 154_{D4} in sequence of miniaturized image frames 170, and high spatial frequency data in sequence of miniaturized image frames 170.

In procedure 380, the sequence of miniaturized image frames are compressed into a dynamic data layer and the quasi-static background into a quasi-static data layer. With reference to FIGS. 2 and 3, data compressor 134 (FIG. 2) compresses sequence of miniaturized image frames 170 (FIG. 3) into a dynamic data layer 144^{k} (generally, and without loss of generality, for the k-th video stream) (FIG. 2). Data compressor 126 compresses sequence of quasi-static background 158 (FIG. 3) into a quasi-static data layer 146^{k} (FIG. 2).

In procedure 382, the dynamic data layer and the quasi-static layer with corresponding setting metadata pertaining to the scene and to at least one ultra-high resolution camera, and corresponding consolidated formatting metadata corresponding to the decomposing procedure and the formatting procedure are encoded. With reference to FIG. 2, data encoder 136 encodes dynamic data layer 144^{k} and quasi-static data layer 146^{k} with corresponding metadata layer 142^{k} pertaining to setting data 140, and consolidated formatting metadata that includes decomposition metadata corresponding to decomposing procedure 374, and formatting metadata corresponding to formatting procedure 378.

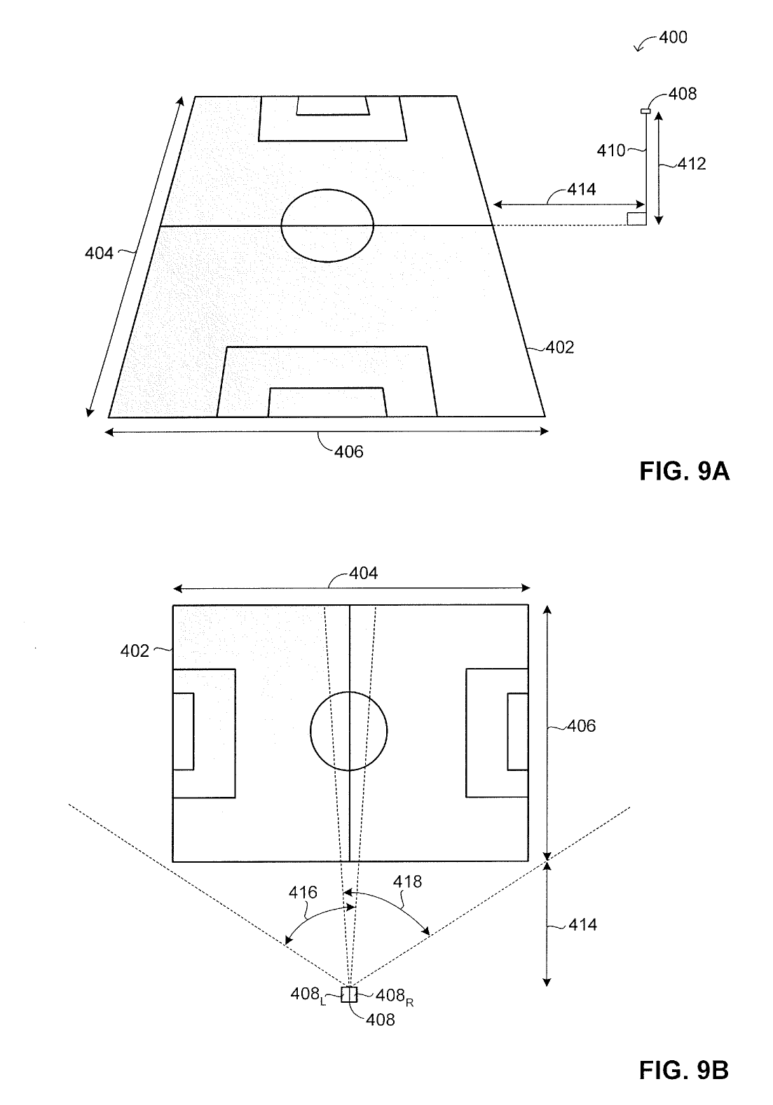

The disclosed technique is implementable in a variety of different applications. For example, in the field of sports that are broadcast live (i.e., in real-time) or recorded for future broadcast or reporting, there are typically players (sport participants (and usually referees)) and a playing field (pitch, ground, court, rink, stadium, arena, area, etc.) on which the sport is being played. For an observer or a camera that has a fixed viewpoint of the sports event (and distanced therefrom), the playing field would appear to be static (unchanging, motionless) in relation to the players that would appear to be moving. The principles of the disclosed technique, as described heretofore may be effectively applied to such applications. To further explicate the applicability of the disclosed technique to the field of sports, reference is now made to FIGS. 9A and 9B. FIG. 9A is a schematic illustration depicting an example installation configuration of the image acquisition sub-system of FIG. 1 in relation to a soccer/football playing field, generally referenced 400, constructed and operative in accordance with another embodiment of the disclosed technique. FIG. 9B is a schematic illustration depicting an example coverage area of the playing field of FIG. 9A by two ultra-high resolution cameras of the image acquisition sub-system of FIG. 1.

Both FIGS. 9A and 9B show a (planar rectangular) soccer/football playing field/pitch 402 having a lengthwise dimension 404 and a widthwise dimension 406, and an image acquisition sub-system 408 (i.e., a special case of image acquisition sub-system 102 of FIG. 1) employing two ultra-high resolution cameras 408_{R} and 408_{L} (sub-index ‘R’ denotes right side, and sub-index ‘L’ denotes left side). Image acquisition sub-system 408 is coupled to and supported by an elevated elongated structure 410 (e.g., a pole) whose height with respect to soccer/football playing field 402 is specified by height dimension 412 (FIG. 9A). The ground distance between image acquisition sub-system 408 and soccer/football playing field 402 is marked by arrow 414. Ultra-high resolution cameras 408_{R} and 408_{L} (FIG. 9B) are typically configured to be adjacent to one another as a pair. FIG. 9B illustrates a top view of playing field 402 where ultra-high resolution camera 408_{L} has a horizontal FOV 416 that mutually overlaps with horizontal FOV 418 of ultra-high resolution camera 408_{R}. Ultra-high resolution camera 408_{R} is oriented with respect to playing field 402 such that its horizontal FOV 418 covers at least the entire right half and at least part of the left half of playing field 402. Correspondingly, ultra-high resolution camera 408_{L} is oriented with respect to playing field 402 such that its horizontal FOV 416 covers at least the entire left half and at least part of the right half of playing field 402. Hence, right ultra-high resolution camera 408_{R} and left ultra-high resolution camera 408_{L} are operative to capture image frames from different yet complementary areas of AOI (playing filed 402). During an installation phase of system 100, the lines-of-sight of ultra-high resolution cameras 408_{R} and 408_{L} are mechanically positioned and oriented to maintain each of their respective fixed azimuths and elevations throughout their operation (with respect to playing field 402). Adjustments to position and orientation parameters of ultra-high resolution cameras 408_{R} and 408_{L} may be made by a technician or other qualified personnel of system 100 (e.g., a system administrator).

Typical example values for the dimensions of soccer/football playing field 402 are for lengthwise dimension 404 to be 100 meters (m.), and for the widthwise dimension 406 to be 65 m. A typical example value for height dimension 412 is 15 m., and for ground distance 414 is 30 m. Ultra-high resolution cameras 408_{R} and 408_{L} are typically positioned at a ground distance of 30 m. from the side-line center of soccer/football playing field 402. Hence, the typical elevation of ultra-high resolution cameras 408_{R} and 408_{L} above soccer/football playing field 402 is 15 m. In accordance with a particular configuration, the position of ultra-high resolution cameras 336_{R} and 336_{L} in relation to soccer/football playing field 402 may be comparable to the position of two lead cameras employed in “conventional” television (TV) productions of soccer/football games and the latter which provide video coverage area of between 85 to 90% of the play time.

In the example installation configuration shown in FIGS. 9A and 9B (with the typical aforesaid dimensions) the horizontal (FOV) staring angle (i.e., of the ultra-high resolution cameras) that is needed to cover the entire playing field 402 lengthwise dimension 404 is approximately 120°. To avoid the possibility of optical distortions (e.g., fish-eye) of occurring when using a single ultra-high resolution camera with a relatively wide FOV (e.g., 120°), two ultra-high resolution cameras 408_{R} and 408_{L} are used each having a horizontal FOV of at least 60° such that their respective coverage areas mutually overlap, as shown in FIG. 9B. Given the aforementioned parameters for the various dimensions, and assuming that the horizontal FOV of each of ultra-high resolution cameras 408_{R} and 408_{L} is 60°, and that the average slant distance from the position of image acquisition sub-system 408 to playing field 402 is 60 m, image acquisition sub-system 408 may achieve the following ground resolution values. (The average slant distance is defined as the average (diagonal) distance between image acquisition subsystem 408 and playfield). In the case where ultra-high resolution cameras 408_{R} and 408_{L} have 4k resolution (2160p, having 3840×2160 pixel resolution) achieving an angular resolution of 60°/3840=0.273 mrad (milli-radians), at a viewing distance of 60 m., the corresponding ground resolution is 1.6 cm/pixel (centimeters per pixel). In the case where ultra-high resolution cameras 408_{R} and 408_{L} have 8k resolution (4320p, having 7680×4320 pixel resolution) achieving an angular resolution of 60°/7680=0.137 mrad, at a viewing distance of 60 m, the corresponding ground resolution is 0.8 cm/pixel. In the case of an intermediate resolution (between 4k and 8k) is used by employing, for example, a “Dalsa Falcon2 12M” camera from DALSA Inc., the ground resolution achieved will be between 1 and 1.25 cm/pixel. Of course, these are but mere examples for demonstrating the applicability of the disclosed technique, as system 100 is not limited to a particular camera, camera resolution, configuration, or values of the aforementioned parameters.

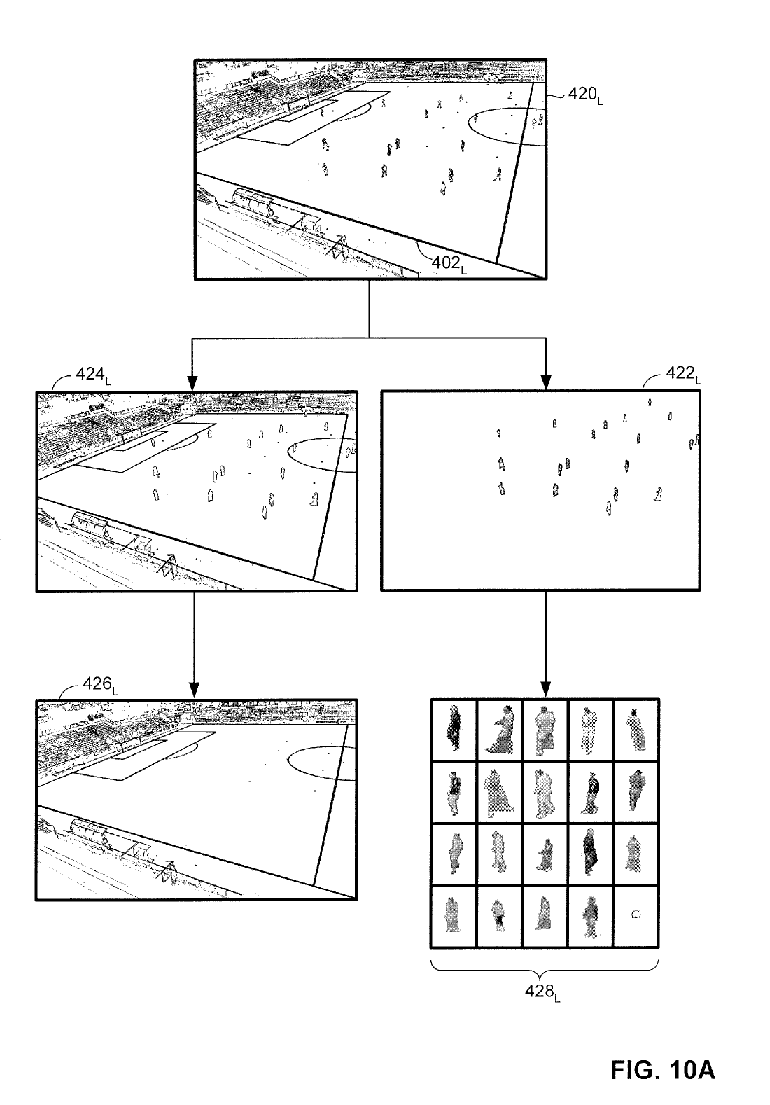

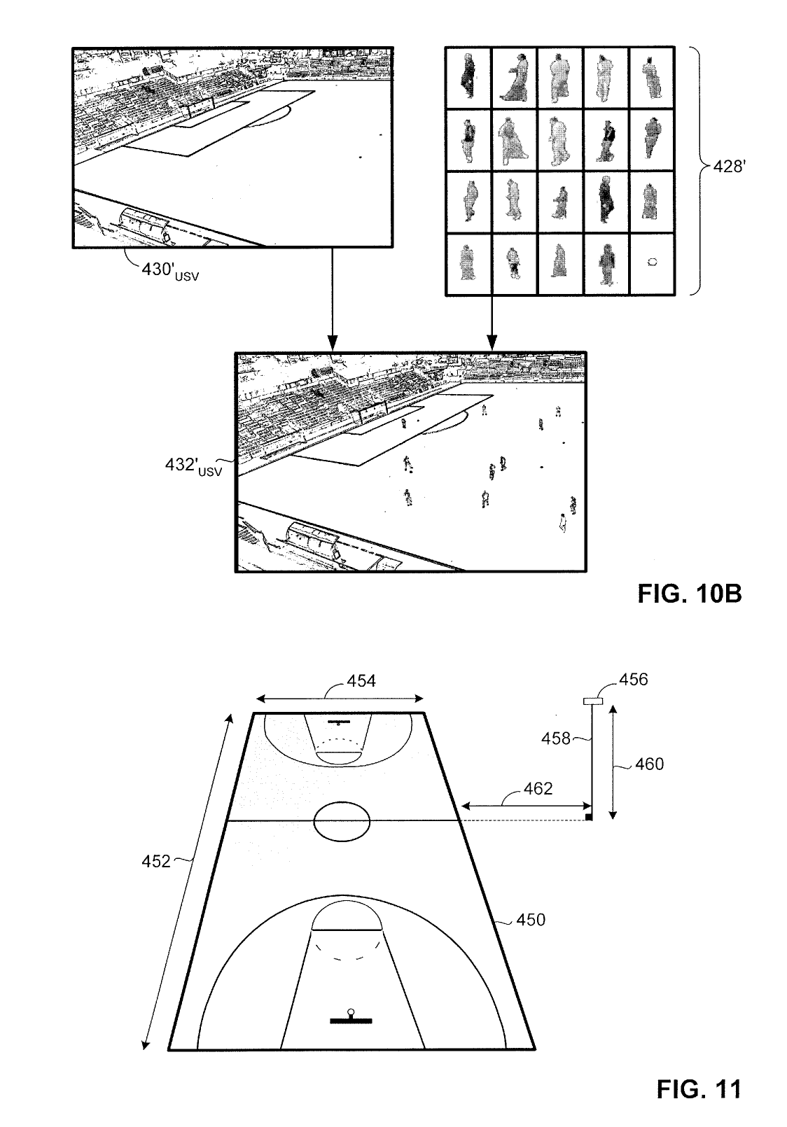

Reference is now further made to FIGS. 10A and 10B. FIG. 10A is a schematic diagram illustrating the applicability of the disclosed technique to the field of broadcast sports, particularly to soccer/football, constructed and operative in accordance with another embodiment of the disclosed technique. FIG. 10B is a schematic diagram illustrating the applicability of the disclosed technique in the field of broadcast sports, particularly to soccer/football, in accordance with and continuation to the embodiment of the disclosed technique shown in FIG. 10A. FIG. 10A illustrates processing functions performed by system 100 in accordance with the description heretofore presented in conjunction with FIGS. 1 through 9B. The AOI in this case is a soccer/football playing field/pitch (e.g., 402, FIGS. 9A and 9B). Left ultra-high resolution camera 408_{L} (FIG. 9B) captures an image frame 420_{L} (FIG. 10A) of a left portion 402_{L} (FIG. 10A) of playing field 402 (not entirely shown in FIG. 10A) corresponding to horizontal FOV 416 (FIG. 9B). Image frame 420_{L} is one in a plurality of image frames (not shown) that are captured of playing field 402 by left ultra-high resolution camera 408. Image frame 420_{L} includes representations of a plurality of players, referees, and the playing ball (not referenced with numbers). Without loss of generality and for conciseness, the left side of a soccer/football playing field is chosen to describe the applicative aspects of the disclosed technique to video capture of soccer/football games/matches. The description brought forth likewise applies to the right side of the soccer/football playing field (not shown).

Server image processing unit 116 (FIG. 2), performs decomposition of image frame 420_{L} into quasi-static background and dynamic objects, which involves a procedure denoted “clean-plate background” removal, in which silhouettes of all of the imaged players, imaged referees and the imaged ball are extracted and removed from image frame 420_{L}. This procedure is essentially parallels decomposition procedure 374 (FIG. 8). Silhouette extraction is represented in FIG. 10A by a silhouette-extracted image frame 422_{L}; clean-plate background removal of the silhouettes is represented by silhouettes-removed image frame 424. Ultimately, decomposition module 124 (FIG. 2) is operative to decompose image frame 420_{L} into a quasi-static background that incorporates background completion (i.e., analogous to image frame 164 of FIG. 3), herein denoted as quasi-static background completed image frame 426_{L} and a matrix of dynamic image features, herein denoted as sequence of miniaturized image frames 428. It is noted that quasi-static background completed image frame 426_{L} may at some instances be realized fully only in consecutive frames to image frame 420, since the completion process may be slower than the video frame rate. Next, formatting module 132 (FIG. 2) formats sequence of miniaturized image frames 428_{L} as follows. Each of the extracted silhouettes of the imaged players, referees, and the ball (i.e., the dynamic objects) is demarcated and formed into a respective miniature rectangular image. Collectively, the miniature rectangular images are arranged into a grid-like sequence or matrix that constitutes a single mosaic image. This arrangement of the miniature images is complemented with metadata that is assigned to each of the miniature images and includes at least the following parameters: bounding box coordinates, player identity, and game metadata. The bounding box (e.g., rectangle) coordinates refer the pixel coordinates of the bounding box corners in relation to the image frame (e.g., image frame 420_{L}) from which a particular dynamic object (e.g., player, referee, ball(s)) is extracted. The player identity refers to at least one attribute that can be used to identify a player (e.g., the number, name, apparel (color and patterns) of a player's shirt, height or other identifiable attributes, etc.). The player identity is automatically recognized by system 100 in accordance with an object tracking and recognition process described hereinabove (e.g., 166 in FIG. 3). Alternatively, dynamic object (player, referee, ball) identifiable information is manually inputted (e.g., by a human operator, via I/O interface 114 in FIG. 1) to the metadata of the corresponding miniature image. Game metadata generally refers to data pertaining to the game/match. Mosaic image 426, interchangeably referred herein as “matrix of miniature image frames” or “sequence of miniature image frames 428_{L}” is processed with corresponding metadata to clients 108₁, . . . , 108_{M} (FIG. 1) at the video frame rate, whereas quasi-static background completed image frame 426_{L} is typically processed (refreshed) at a relatively slower frame rate (e.g., once every minute, half-minute, etc.). Analogously, for right side of playing field 420_{R}, mosaic image 428_{R} (not shown) is processed with corresponding metadata at the video frame rate, whereas a quasi-static background completed image frame 426_{R} (not shown) is typically processed at a relatively slower frame rate. Server processing unit 110 (FIG. 1) rearranges mosaic image 426_{L} and mosaic image 426_{R} (not shown) so as to generate a consolidated mosaic image 426 (not shown) in such that no same dynamic object (e.g., player, referee, ball) exists or is represented more than once therein. Furthermore, the same spatial order (i.e., sequence) of the miniature image frames within consolidated mosaic image 426 is preserved during subsequent video image frames (i.e., image frames that follow image frame 4200 to the maximum extent possible. Particularly, server image processing unit 116 and specifically formatting module 132 thereof is operative to: eliminate redundant content (i.e., each player and referee is represented only once in consolidated mosaic image 426), to reduce inter-frame motion (i.e., each miniaturized image is maintained at the same position in consolidated mosaic image 426), and to size the miniature image frames (cells) in multiples of preferably 16×16 blocks (that may include dummy pixels, if reckoned appropriate) so as to improve encoding efficiency and to reduce unnecessary high spatial frequency content. Blocks of other sizes are also applicable (2×2 sized blocks, 4×4 sized blocks, etc.). Server processing unit 110 is operative to seamlessly combine quasi-static background completed image frame 426_{L} with quasi-static background completed image frame 426_{R} (not shown) to generate a combined quasi-static background completed image frame 426 (not shown).

Server 104 (FIG. 1) is further operative to execute and maintain Internet protocol (IP) based communication via communication medium 120 with a plurality of clients 108₁, . . . , 108_{M} (e.g., interchangeably “user terminals”, “client nodes”, “end-user nodes”, “client hardware”, etc.). To meet and maintain the stringent constraints associated with real-time transmission (e.g., broadcast) of imaged playing field 402, server 104 performs the following sub-functions. The first sub-function involves reformatting or adaptation of consolidated image matrix 428 such that it contains the information needed to meet a user selected viewing mode. This first sub-function further involves encoding, compression and streaming of consolidated image matrix 428 data at the full native frame rate to the user terminal. The second sub-function involves encoding, compression and streaming of quasi-static background completed image frame 426 data at a frame rate comparatively lower than the full native frame rate.

At the client side, a program, an application, software, and the like is executed (run) on the client hardware that is operative to implement the functionality afforded by system 100. Usually this program is downloaded and installed on the user terminal. Alternatively, the program is hardwired, already installed in memory or firmware, run from nonvolatile or volatile memory of the client hardware, etc. The client receives and processes in real-time (in accordance with the principles heretofore described) two main data layers, namely, the streamed consolidated image matrix 428 data (including corresponding metadata) at the full native frame rate as well as quasi-static background completed image frame 426 data at a comparatively lower frame rate. First, the client (i.e., at least one of clients 108₁, . . . , 108_{M}) renders (i.e., via client processing unit 180) data pertaining to the quasi-static background, in accordance with user input 220 (FIG. 4B) for a user selected view (FIG. 5B) that specifies the desired line-of-sight (i.e., defined by virtual camera look vector 268₁, FIG. 5B) and FOV (i.e., defined by the selected view volume of virtual camera 266₁) in order to generate a corresponding user selected view quasi-static background image frame 430′_{USV} (FIG. 10B). The subscript “USV” used herein is an acronym for “user selected view”. Second, client processing unit 180 reformats received (decoded and de-compressed) consolidated mosaic image 428′ containing the miniaturized image frames so as to insert each of them to its respective position (i.e., coordinates in image space) and orientation (i.e., angles) with respect to the coordinates of selected view quasi-static background image frame 430′_{USV} (as determined by metadata). The resulting output from client processing unit 180 (i.e., particularly, client image processing unit 190) is a rendered image frame 432′_{USV} (FIG. 10B) from the selected view of the user. Rendered image frame 432′_{USV} is displayed on client display 188 (FIG. 4A). This process is performed in real-time for a plurality of successive image frames, and independently for each end-user (and associated user selected view). Prior to insertion, the miniaturized image frames in (decoded and de-compressed) consolidated mosaic image 428′ are adapted (e.g., re-scaled, color-balanced, etc.) accordingly so as to conform to the image parameters (e.g., chrominance, luminance, etc.) of selected view quasi-static background image frame 430′_{USV}.

System 100 allows the end-user to select via I/O interface 184 (FIG. 4A) at least one of several possible viewing modes. The selection and simultaneous display of two or more viewing modes is also viable (i.e., herein referred as a “simultaneous viewing mode”). One viewing mode is a full-field display mode (not shown) in which the client (node) renders (i.e., via client image processing unit 190 thereof) and displays (i.e., via client display 188) a user selected view image frame (not shown) of entire playing field 402. In this mode consolidated mosaic image 428′ includes reformatted miniaturized image frames of all the players, referees (and ball(s)) such that they are located anywhere throughout the entire area of a selected view quasi-static background image frame (not shown) of playing field 402. It is noted that the resolution of a miniature image frame of the ball is consistent (e.g., matches) with the display resolution at the user terminal.

Another viewing mode is a ball-tracking display mode in which the client renders and displays image frames of a zoomed-in section of playing field 402 that includes the ball (and typically neighboring players) at full native (“ground”) resolution. Particularly, the client inserts (i.e., via client image processing unit 190) adapted miniature images of all the relevant players and referees whose coordinate values correspond to one of the coordinate values of the zoomed-in section. The selection of the particular zoomed-in section that includes the ball is automatically determined by client processing unit 190, at least partly according to object tracking and motion prediction methods.

A further viewing mode is a manually controlled display mode in which the end-user directs the client to render and display image frames of a particular section of playing field 402 (e.g., at full native resolution). This viewing mode enables the end-user to select in real-time a scrollable imaged section of playing field 402 (not shown). In response to a user selected imaged section (via user input 220, FIG. 4B), client processing unit 180 renders in real-time image frames according to the attributes the user's selection such that the image frames contain adapted (e.g., scaled, color-balanced) miniature images of the relevant player(s) and/or referees and/or ball at their respective positions with respect to the user selected scrolled imaged section.

Another viewing mode is a “follow-the-anchor” display mode in which the client renders and displays image frames that correspond to a particular imaged section of playing field 402 as designated by manual (or robotic) control or direction of an operator, a technician, a director, or other functionary (referred herein as “anchor”). In response to the anchor selected imaged section of playing field 402, client processing unit 180 inserts adapted miniature images of the relevant player(s) and/or referees and/or ball at their respective positions with respect to the anchor selected imaged section.

In the aforementioned viewing modes, the rendering of a user selected view image frame by image rendering module 206 (FIG. 4B) and the insertion or inclusion of the relevant miniaturized image frames derived from consolidated mosaic image 428′ to an outputted image is performed at the native (“TV”) frame rate. As mentioned, the parts of the rendered user selected view image frame relating to the quasi-static background (e.g., slowly changing illumination conditions due to changing weather or the sun's position) are refreshed at a considerably slower rate in comparison to dynamic image features relating to the players, referees and the ball. Since the positions and orientations of all the dynamic (e.g., moving) features are known (due to accompanying metadata) together with their respective translated (mapped) positions in the global coordinate system, their respective motion parameters (e.g., instantaneous speed, average speed, accumulated traversed distance) may be derived, quantified, and recorded. As discussed with respect to FIG. 6A, the user-to-system interactivity afforded by system 100 allows real-time information to be displayed relating to a particular object (e.g., player) in response to user input. In particular, system 100 supports real-time user interaction with displayed images. For example, a displayed image may be “clickable” (by a pointing device (mouse)), “touchable” (via a touchscreen), such that user input is linked to contextually-related information, like game statistics/analytics, special graphical effects, sound effects and narration, “smart” advertising, 3^{rd} party applications, and the like.

Reference is now made to FIG. 11, which is a schematic illustration in perspective view depicting an example installation configuration of the image acquisition sub-system of FIG. 1 in relation to a basketball court, constructed and operative in accordance with a further embodiment of the disclosed technique. FIG. 11 shows a basketball court 450 having a lengthwise dimension 452 and a widthwise dimension 454, and an image acquisition sub-system 456 (i.e., a special case of image acquisition sub-system 102 of FIG. 1) typically employing two ultra-high resolution cameras (not shown). Image acquisition sub-system 456 is coupled to and supported by an elevated elongated structure 458 (e.g., a pole) whose height with respect to the level basketball court 450 is specified by height dimension 460. The ground distance between image acquisition sub-system 456 and basketball court 450 is marked by 462. The two ultra-high resolution cameras are typically configured to be adjacent to one another as a pair (not shown), where one of the cameras is positioned and oriented (calibrated) to have a FOV that covers at least one half of basketball court 450, whereas the other camera is calibrated to have a FOV that covers at least the other half of basketball court 450 (typically with an area of mutual FOV overlap). During an initial installation phase of system 100, the lines-of-sight of the two ultra-high resolution cameras are mechanically positioned and oriented to maintain each of their respective fixed azimuths and elevations throughout their operation (with respect to basketball court 450). Image acquisition sub-system 456 may include additional ultra-high resolution cameras (e.g., in pairs) installed and situated at other positions (e.g., sides) in relation to basketball court 450 (not shown).

Given the smaller dimensions of basketball court 450 in comparison to soccer/football playing field 402 (FIGS. 9A and 9B), a typical example of the average slant distance from image acquisition sub-system 456 to basketball court 450 is 20 m. Additional typical examples values for the dimensions of a basketball court 450 are for lengthwise dimension 452 to be 28.7 m. and for the widthwise dimension 454 to be 15.2 m. A typical example value for height dimension 460 is 4 m., and for ground distance 462 is 8 m. Assuming the configuration defined above with respect to values for the various dimensions, image acquisition sub-system 456 may employ two ultra-high resolution cameras having 4k resolution thereby achieving an average ground resolution of 0.5 cm/pixel. Naturally, the higher the ground resolution that is attained, the greater the resultant sizes of the miniature images will become (representing the players, the referee and the ball), and consequently the greater corresponding information content that has to be communicated to the client side in real-time. This probable increase in the information content is to some extent compensated by the fact that a standard game of basketball involves a lesser number of participants in comparison to a standard game of soccer/football. Apart from the relevant differences mentioned, all system configurations and functionalities heretofore described likewise apply the current embodiment.

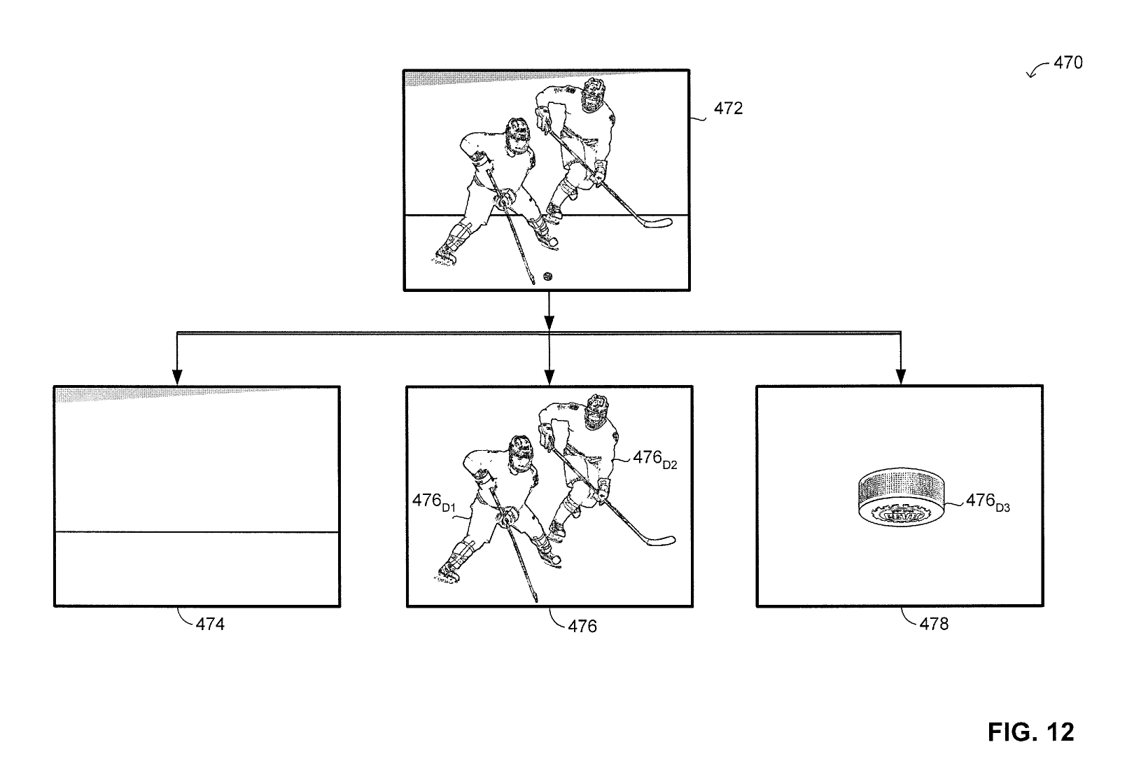

Reference is now made to FIG. 12, which is a schematic diagram illustrating the applicability of the disclosed technique to the field of broadcast sports, particularly to ice hockey, generally referenced 470, constructed and operative in accordance with another embodiment of the disclosed technique. FIG. 12 shows an image frame 472 captured by one of ultra-high resolution cameras 102₁, . . . , 102_{N} (FIG. 1). The system and method of the disclosed technique as heretofore described likewise apply to the current embodiment, particularly taking into account the following considerations and specifications.

Given the relatively small dimensions (e.g., 25 mm (thickness)×76 mm (diameter)) and typically high speed motion (e.g., 100 miles per hour or 160 km/h) of the ice hockey puck (or for brevity “puck”) (i.e., relative to a soccer/football ball or basketball) the image processing associated therewith is achieved in a slightly different manner. To achieve smoother tracking of the rapidly varying position of the imaged puck in successive video image frames of the video stream (puck “in-video position”), the video capture frame rate is increased to typically double (e.g., 60 Hz.) the standard video frame rate (e.g., 30 Hz.). Other frame rate values are viable. Current ultra-high definition television (UHDTV) cameras support this frame rate increase. Alternatively, other values for increased frame rates in relation to the standard frame rate are viable. System 100 decomposes image frame 472 into a quasi-static background 474 (which includes part of a hockey field), dynamic image features 476 that include dynamic image features 476_{D1} (ice hockey player 1), 476_{D2} (ice hockey player 2), and high-speed dynamic image features 478 that includes high-speed dynamic image feature 476_{D3} (puck). For a particular system configuration that provides a ground imaged resolution of, for example 0.5 cm/pixel, the imaged details of the puck (e.g., texture, inscriptions, etc.) may be unsatisfactory. In such cases, server image processing unit 116 (FIGS. 1 and 2) may generate a rendered image of puck (not shown) such that client image processing unit 190 is operative to insert the rendered image of the puck at its respective position in an outputted image frame according to metadata corresponding to spatial position of the real extracted miniature image of puck 476_{D3}. This principle may be applied to other fields in sport where there is high speed motion of dynamic objects, such as baseball, tennis, cricket, and the like. Generally, AOI 106 may be any of the following examples: soccer/football field, Gaelic football/rugby, pitch, basketball court, baseball field, tennis court, cricket pitch, hockey filed, ice hockey rink, volleyball court, badminton court, velodrome, speed skating rink, curling rink, equine sports track, polo field, tag games fields, archery field, fistball field, handball field, dodgeball court, swimming pool, combat sports rings/areas, cue sports tables, flying disc sports fields, running tracks, ice rink, snow sports areas, Olympic sports stadium, golf field, gymnastics arena, motor racing track/circuit, board games boards, table sports tables (e.g., pool, table tennis (ping pong)), and the like.

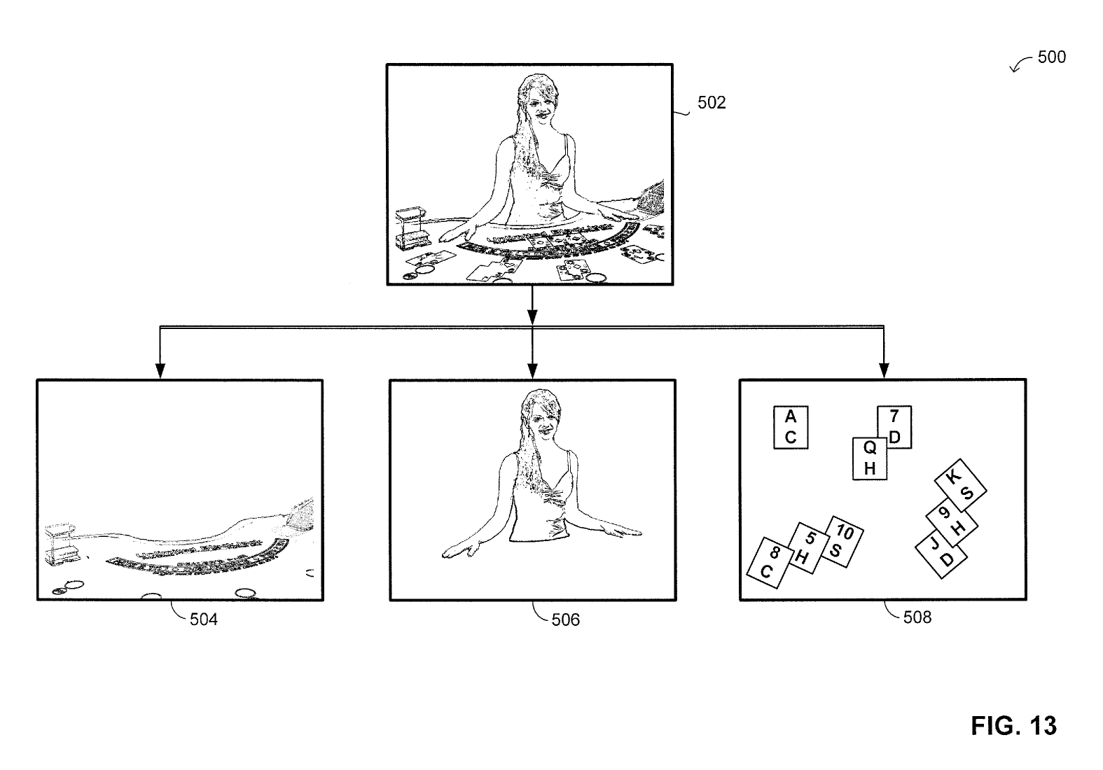

The principles of the disclosed technique likewise apply to other non-sports related events, where live video broadcast is involved, such as in live concerts, shows, theater plays, auctions, as well as in gambling (e.g., online casinos). For example AOI 106 may be any of the following: card games tables/spaces, board games boards, casino games areas, gambling areas, performing arts stages, auction areas, dancing grounds, and the like. To demonstrate the applicability of the disclosed technique to non-sports events, reference is now made to FIG. 13, which is a schematic diagram illustrating the applicability of the disclosed technique to the field of card games, particularly to blackjack, generally referenced 500, constructed and operative in accordance with a further embodiment of the disclosed technique. During broadcast (e.g., televised transmission) of live card games (like blackjack (also known as twenty-one) and poker), the user's attention is usually primarily drawn to the cards that are dealt by a dealer. Generally, the images of the cards have to exhibit sufficient resolution in order for end-users on the client side to be able to recognize their card values (i.e., number values for numbered cards, face values for face cards, and ace values (e.g., 1 or 11) for an ace card(s)).

The system and method of the disclosed technique as heretofore described likewise apply to the current embodiment, particularly taking into account the following considerations and specifications. Image acquisition sub-system 102 (FIG. 1) typically implements a 4k ultra-high resolution camera (not shown) having a lens that exhibits a 60° horizontal FOV that is fixed at an approximately 2 m. average slant distance from an approximately 2 m. long blackjack playing table, such to produce an approximately 0.5 mm/pixel resolution image of the blackjack playing table. FIG. 13 shows an example image frame 502 captured by the ultra-high resolution camera. According to the principles of the disclosed technique heretofore described, system 100 decomposes image frame 502 into quasi-static background 504, dynamic image features 506 (the dealer) and 508 (the playing cards, for brevity “cards”). The cards are image-captured with enough resolution to enable server image processing unit 116 (FIG. 2) to automatically recognize their values (e.g., via object recognition module 130, by employing image recognition techniques). Given that a deck of cards has a finite set of a priori known card values, the automated recognition process is rather straightforward to system 100 (i.e., does not entail the complexity of recognizing a virtually infinite set of attributes). Advantageously, during an initial phase in the operation of system 100, static images of the blackjack table, its surroundings, as well as an image library of playing cards are transmitted in advance (i.e., prior to the start of the game) to the client side and stored in client memory device 186 (FIG. 4A). During the game, typically only the extracted (silhouette) image of the dealer (and corresponding (e.g., position) metadata), the value of the cards (and corresponding (e.g., positions) metadata) have to be transmitted to the client side, effectively reducing in a considerable manner the quantity of data required to be transmitted. Based on the received metadata of the cards, client image processing unit 190 (FIG. 4B) may render images of the cards at any applicable resolution that is preferred and selected by the end-user, thus allowing for enhanced card legibility.

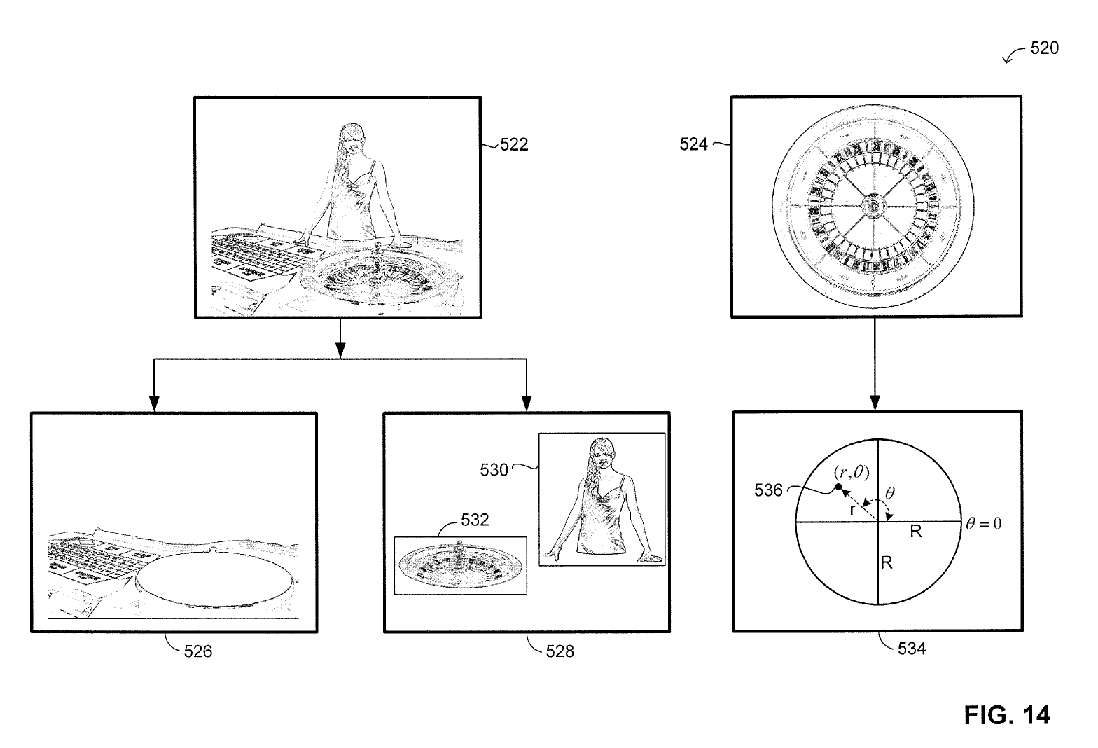

Reference is now made to FIG. 14, which is a schematic diagram illustrating the applicability of the disclosed technique to the field of casino games, particularly to roulette, generally referenced 520, constructed and operative in accordance with another embodiment of the disclosed technique. During broadcast (e.g., televised transmission) of live casino games, like roulette, the user's attention is usually primarily drawn to the spinning wheel and the position of the roulette ball in relation to the spinning wheel. Generally, the numbers marked on the spinning wheel and roulette ball have to exhibit sufficient resolution in order for end-users on the client side to be able to discern the numbers and the real-time position of the roulette ball in relation to the spinning wheel.

The system and method of the disclosed technique as heretofore described likewise apply to the current embodiment, particularly taking into account the following considerations and specifications. The configuration of the system in accordance with the present embodiment typically employs two cameras. The first camera is a 4k ultra-high resolution camera (not shown) having a lens that exhibits a 60° horizontal FOV that is fixed at an approximately 2.5 m. average slant distance from an approximately 2.5 m. long roulette table, such to produce an approximately 0.7 mm/pixel resolution image of the roulette table (referred herein “slanted-view camera”). The second camera, which is configured to be pointed in a substantially vertical downward direction to the spinning wheel section of the roulette table, is operative to produce video frames with a resolution typically on the order of, for example 2180×2180 pixels, that yield an approximately 0.4 mm./pixel resolution image of the spinning wheel section (referred herein “downward vertical view camera”). The top left portion of FIG. 14 shows an example image frame 522 of the roulette table and croupier (dealer) as captured by the slanted-view camera. The top right portion of FIG. 14 shows an example image frame 524 of the roulette spinning wheel as captured by the vertical view camera.

According to the principles of the disclosed technique heretofore described, system 100 decomposes image frame 522 generated from the slanted-view camera into a quasi-static background 526 as well as dynamic image features 528, namely, miniature image of croupier 530, and miniature image of roulette spinning wheel 532 shown in FIG. 14 delimited by respective image frames. Additionally, system 100 (i.e., server processing unit 110) utilizes the images captured by the downward vertical view camera to extract (e.g., via image processing techniques) the instantaneous rotation angle of roulette spinning wheel (not shown) as well as the instantaneous position of the roulette ball 536, thereby forming corresponding metadata 534. The disclosed technique is in general, operative to classify dynamic (e.g., moving) features by employing an initial classification (i.e., determining “course” parameters such as motion characteristics; a “course identity” of the dynamic image features in question) and a refined classification (i.e., determining more definitive parameters; a more “definitive identity” of the dynamic image features in question). Dynamic features or objects may thus be classified according to their respective motion dynamics (e.g., “fast moving”, “slow moving” features/objects). The outcome of each classification procedure is expressed (included) in metadata that is assigned to each dynamic image feature/object. Accordingly, the roulette ball would be classified as a “fast moving” object, whereas the croupier would generally be classified as a “slow moving” object. As shown in FIG. 14, the position of roulette ball 536 with respect to roulette spinning wheel may be represented by polar coordinates (r, θ), assuming the roulette spinning wheel is circular of radius R. The downward vertical view camera typically captures images at double (e.g., 60 Hz.) the standard video frame rate (e.g., 30 Hz.) so as to avert motion smearing. Advantageously, during an initial phase in the operation of system 100, static images of the roulette table, its surroundings, as well as a high resolution image of the spinning wheel section are transmitted in advance (i.e., prior to the start of the online session) to the client side and stored in client memory device 186 (FIG. 4A). During the online session, typically only the extracted (silhouette) miniature image frame of the croupier 530 (with corresponding metadata), (low resolution) miniature image frame of roulette spinning wheel 532 (with corresponding metadata) as well as the discrete values of angular orientation of the roulette spinning wheel and the instantaneous positions of the roulette ball 536 is transmitted from the server to the clients. In other words, the roulette spinning wheel metadata and roulette ball metadata 534 are transmitted rather than a real-time spinning image of the roulette spinning wheel and a real-time image of the roulette ball. The modus operandi thus presented effectively reduces to a considerable extent the quantity of data that is required to be transmitted for proper operation of the system so as to deliver a pleasant viewing experience to an end-user.

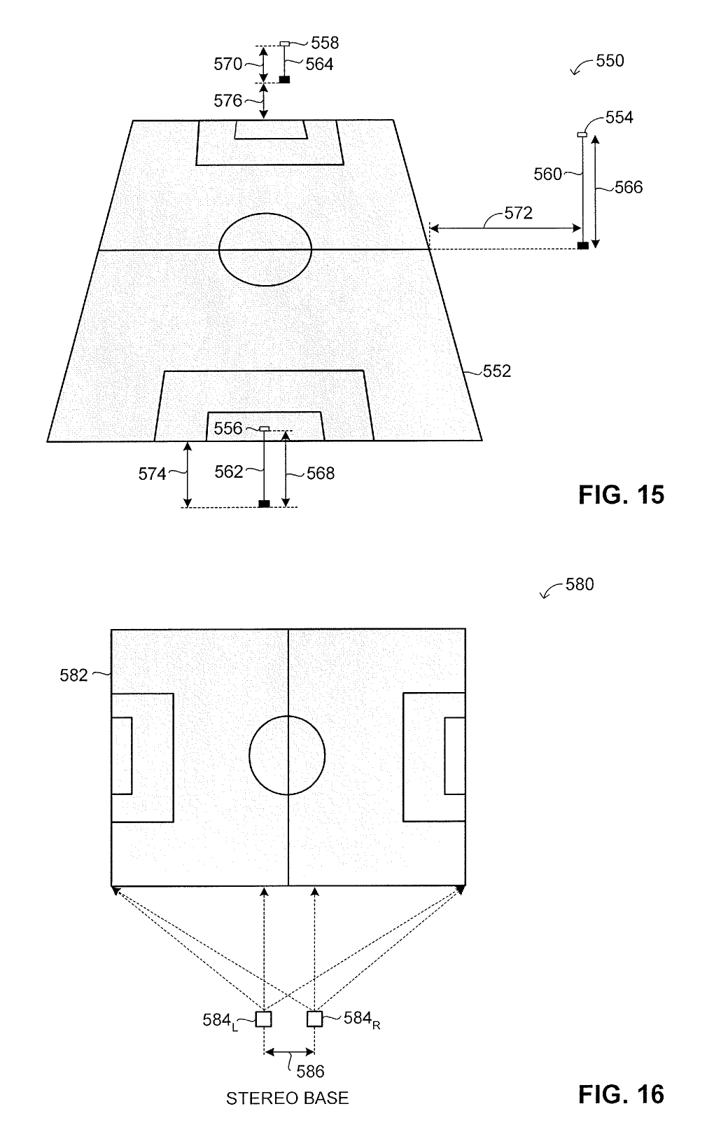

The disclosed technique enables generation of video streams from several different points-of-view of AOI 106 (e.g., soccer/football stadiums, tennis stadiums, Olympic stadiums, etc.) by employing a plurality of ultra-high resolution cameras, each of which is fixedly installed and configured at particular advantageous position of AOI 106 or a neighborhood thereof. To further demonstrate the particulars of such an implementation, reference is now made to FIG. 15, which is a schematic diagram illustrating a particular implementation of multiple ultra-high resolution cameras fixedly situated to capture images from several different points-of-view of an AOI, in particular a soccer/football playing field, generally referenced 550, constructed and operative in accordance with a further embodiment of the disclosed technique. Multiple camera configuration 550 as shown in FIG. 15 illustrates a soccer/football playing field 552 including image acquisition sub-systems 554, 556, and 558, each of which includes at least one ultra-high resolution camera (not shown). Image acquisition sub-systems 554, 556 and 558 are each respectively coupled to and respectively supported by respective elevated elongated structures 560, 562, and 564 whose respective height with respect to soccer/football playing field 552 is specified by respective height dimensions 566, 568, and 570. The ground distances between each of image acquisition sub-systems 554, 556, and 558 respective fixed positions to soccer/football playing field 552 is respectively marked by arrows 572, 574, and 576. Typical example values for height dimensions 566, 568, and 570 are similar to height dimension 412 (FIG. 9A, i.e., 15 m.). Typical example values for ground distances 572, 574, and 576 are similar to ground distance 414 (FIG. 9A, i.e., 30 m.). System 100 is operative to enable end-users the ability to select the video source, namely, video streams generated by at least one of image acquisition sub-systems 554, 556, and 558. The ability to switch between the different video sources can significantly enrich the user's viewing experience. Additional image acquisition sub-systems may be used (not shown). The fact that players, referees, and the ball are typically imaged in this configuration from two, three (or more) viewing angles, is pertinent for reducing instances of mutual obscuration between players/referees in the output image. System 100 may further correlate between metadata of different mosaic images (e.g., 428, FIG. 10A) that originate from different respective image acquisition sub-systems 554, 556, and 558 so as to form consolidated metadata for each dynamic image feature (object) represented within the mosaic images. The consolidated metadata improves estimation of the inter-frame position of objects in their respective miniaturized image frames.

The disclosed technique is further constructed and operative to provide stereoscopic image capture of the AOI. To further detail this aspect of the disclosed technique, reference is now made to FIG. 16, which is a schematic diagram illustrating a stereo configuration of the image acquisition sub-system, generally referenced 580, constructed and operative in accordance with another embodiment of the disclosed technique. FIG. 16 illustrates an AOI, exemplified as a soccer/football playing field 582, and an image acquisition sub-system that includes two ultra-high resolution cameras 584_{R} (right) and 584_{L} (left) that are separated by a distance 586, also referred to as a “stereo base”. It is known that the value of stereo base 586 that is needed for achieving the “optimal” stereoscopic effect is mainly a function of the minimal distance to the photographed/imaged objects as well as the focal length of the optics employed by the ultra-high resolution cameras 584_{R} and 584. Typical optimal values for stereo base 586 lie between 70 and 80 cm. Server processing unit 110 produces a left mosaic image (not shown, e.g., 428, FIG. 10A) from image frames captured by left ultra-high resolution camera 584_{R} of soccer/football field 582. Similarly, server processing unit 110 produces a right mosaic image (not shown) from image frames captured by right ultra-high resolution camera 584_{R} of soccer/football field 582. The left and right mosaic images are transmitted from the server side to the client side. At the client side, the received left and right mosaic images are processed so as to rescale the miniaturized image frames contained therein representing the dynamic objects (e.g., players, referees, ball(s)). Once rescaled, the dynamic objects contained in the miniaturized image frames of the left and right mosaic images are inserted into a rendered image (not shown) of an empty playing field 582, so as to generate a stereogram (stereoscopic image) that typically consists of two different images intended for projecting/displaying respectively to the left and right eyes of the user.

The viewing experience afforded to the end-user by system 100 is considerably enhanced in comparison to that provided by standard TV broadcasts. In particular, the viewing experience provided to the end-user offers the ability to control the line-of-sight and the FOV of the images displayed, as well as the ability to directly interact with the displayed content. While viewing sports events, users are typically likely to utilize the manual control function in order to select a particular virtual camera and/or viewing mode for only a limited period of time, as continuous system-to-user interaction by the user may be a burden on the user's viewing experience. At other times, users may simply prefer to select the “follow-the-anchor” viewing mode. System 100 further allows video feed integration such that the regular TV broadcasts may be incorporated and displayed on the same display used by the system 100 (e.g., via a split-screen mode, a PiP mode, a feed switching/multiplexing mode, multiple running applications (windows) mode, etc.). In another mode of operation of system 100, the output may be projected on a large movie theater screen by two or more digital 4k resolution projectors that display real-time video of the imaged event. In a further mode of operation of system 100, the output may be projected/displayed as a live 8k resolution stereoscopic video stream where users wear stereoscopic glasses (“3-D glasses”).

Performance-wise, system 100 achieves an order of magnitude reduction in bandwidth, while employing standard encoding/decoding and compression/decompression techniques. Typically, the approach by system 100 allows a client to continuously render in real-time high quality video imagery fed by the following example data streaming rates: (i) 100-200 Kbps (kilobytes per second) for the standard (SD) video format; and (ii) 300-400 Kbps for the high-definition (HD) video format.

System-level design considerations include, among other factors, choosing the ideal resolution of the ultra-high resolution cameras so as to meet the imaging requirements of the particular venue and event to be imaged. For example, a soccer/football playing field would typically require centimeter-level resolution. To meet this requirement, as aforementioned, two 4k resolution cameras can yield a 1.6 cm/pixel ground resolution of a soccer/football playing field, while two 8k resolution cameras can yield a 0.8 cm/pixel ground resolution. At such centimeter-level resolution, a silhouette (extracted portion) of a player/referee can be effectively represented by approximately, a total of 6,400 pixels. For example, at centimeter level resolution, TV video frames may show perhaps an average, of about ten players per frame. The dynamic (changing, moving) content of such image frames is 20% of the total pixel count for standard SD resolution (e.g., 640×480 pixels) image frames and only a 7% of the total pixel count for standard HD resolution (e.g., 1920×1080) image frames. As such, given the fixed viewpoints of the ultra-high resolution cameras, it is a typically experienced that the greater the resolution of the captured images, the greater the ratio of quasi-static data to dynamic image feature data there is needed to be conveyed to the end-user, and consequently the amount of in-frame information content communicated is significantly reduced.

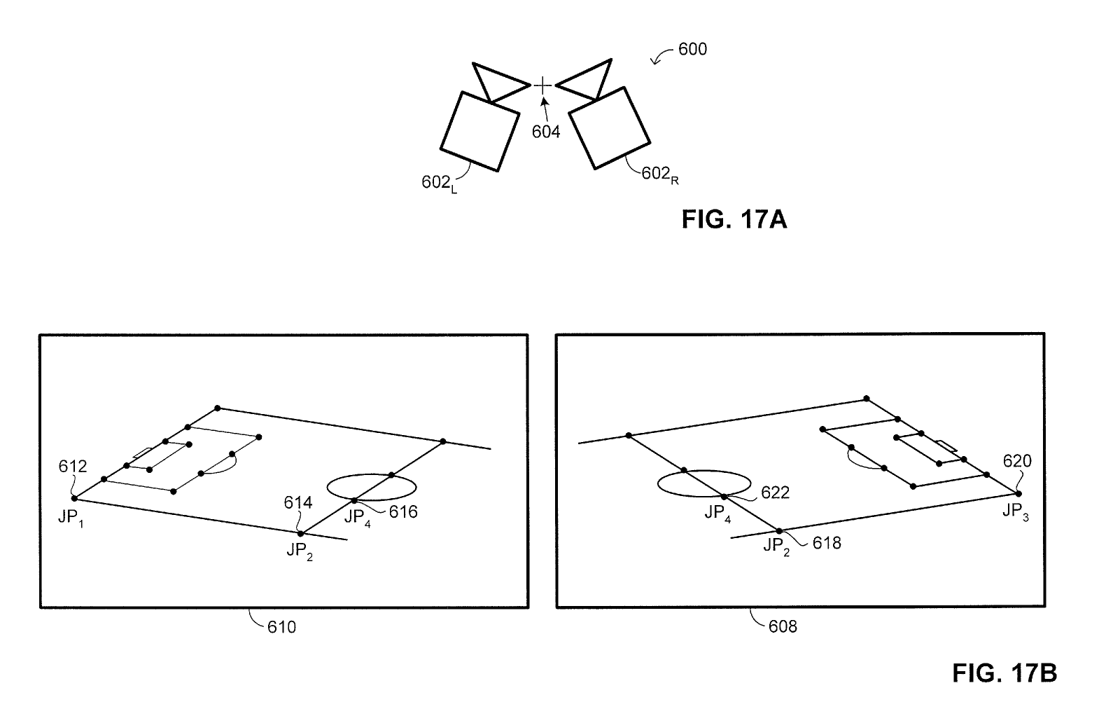

To ensure proper operation of the ultra-high resolution cameras, especially in the case of a camera pair that includes two cameras that are configured adjacent to one another, a number of calibration procedures are usually performed, prior to the operation (“showtime”) of system 100. Reference is now made to FIGS. 17A and 17B. FIG. 17A is a schematic diagram illustrating a calibration configuration between two ultra-high resolution cameras, generally referenced 600, constructed and operative in accordance a further embodiment of the disclosed technique. FIG. 17B is a schematic diagram illustrating a method of calibration between two image frames captured by two adjacent ultra-high resolution cameras, constructed and operative in accordance with embodiment of the disclosed technique. FIG. 17A shows two ultra-high resolution cameras 602_{R} and 602_{L} that are configured adjacent to one another so as to minimize the parallax effect. The calibration process typically involves two sets of measurements. In the first set of measurements, each ultra-high resolution camera undergoes an intrinsic calibration process during which its optical (radial and tangential) distortions are measured and stored in a memory device (e.g., memory 118, FIG. 1), such to compile in a look-up table for computational (optical) corrections. This is generally a standard procedure for photogrammetric applications of imaging cameras. In the second set of measurements, referred to as extrinsic or exterior calibration process, is carried in two steps. In the first step, following installation of the cameras at the venue or AOI, a series of images are captured of the AOI (e.g., of an empty playing field). As shown in FIG. 17B, right ultra-high resolution camera 602_{R} captures a calibration image 608 of the AOI (e.g., an empty soccer/football playing field) in accordance with its line-of-sight. Similarly, left ultra-high resolution camera 602_{L} captures a calibration image 610 of the AOI (e.g., an empty soccer/football playing field) in accordance with its line-of-sight. Calibration images 608 and 610 are of the same soccer/football playing field captured from different viewpoints. Calibration images 608 and 610 each include a plurality of well-identifiable junction points, labeled JP₁, JP₂, JP₃, JP₄, and JP₅. In particular, calibration image 608 includes junction points 618, 620 and 622, and calibration image 610 includes junction points 612, 614, and 616. All such identified junction points have to be precisely located on the AOI (e.g., ground of the soccer/football playing field) with their position measured with respect to the global coordinate system. Once all the junction points have been identified in calibration images 608 and 610 they are logged and stored in system 100. The calibration process involves associating junction points (and their respective coordinates) between calibration images 608 and 610. Specifically, for junction point JP₂, denoted 618 in calibration image 608 is associated with its corresponding junction point denoted 614 in calibration image 610. Similarly, for junction point JP₄, denoted 622 in calibration image 608 is associated with its corresponding junction point denoted 616 in calibration image 610, and so forth for other junction points.

Based on the intrinsic and extrinsic calibration parameters, the following camera harmonization procedure is performed in two phases. In the first phase, calibration images 608 and 610 (FIG. 17B) generated respectively by ultra-high resolution cameras 602_{R} and 602_{L} undergo an image solving process, whereby the precise location of the optical centers of the cameras with respect the global coordinate system is determined. In the second phase, the precise transformation between the AOI (ground) coordinates and corresponding pixel coordinates in each generated image is determined. This transformation is expressed or represented in a calibration look-up table and stored in the memory device (e.g., memory 118, FIG. 1) of server 104. The calibration parameters enable system 100 to properly perform the following functions. Firstly, server 104 uses these parameters to render the virtual image of an empty AOI (e.g., an empty soccer/football field) by seamlessly mapping images generated by right ultra-high resolution camera 602_{R} with corresponding images generated by left ultra-high resolution camera 602_{L} to form a virtual image plane (not shown). Secondly, server 104 rescales and inserts the miniaturized images of the dynamic objects (e.g., players, referee, ball), using the consolidated mosaic image (e.g., 428) to their respective positions in a rendered image (not shown) of the empty playing field. Based on the calibration parameters, all relevant image details that are located elevation-wise on the playing field level can be precisely mapped onto the virtual image of the empty playing field. Any details located at a certain height above the playing field level may be subject to small mapping errors due to parallax angles that exist between the optical centers of ultra-high resolution cameras 602_{R} and 602_{L} and the line-of-sight of the virtual image (of the empty soccer/football playing field). As aforementioned, to minimize parallax errors, the lenses of ultra-high resolution cameras 602_{R} and 602_{L} are positioned as close to each other as possible, such that a center-point 604 (FIG. 17A) of a virtual image of the empty AOI (e.g., soccer/football playing field) is positioned as schematically depicted in FIG. 17A.

It will be appreciated by persons skilled in the art that the disclosed technique is not limited to what has been particularly shown and described hereinabove. Rather the scope of the disclosed technique is defined only by the claims, which follow.

1. A method for encoding a video stream generated from at least one ultra-high resolution camera capturing a plurality of sequential image frames from a fixed viewpoint of a scene, the method comprising the procedures of:
decomposing said sequential image frames into quasi-static background and dynamic image features;
distinguishing between different objects represented by said dynamic image features by recognizing characteristics of said objects and by tracking movement of said objects in said sequential image frames;
formatting said dynamic image features into a sequence of miniaturized image frames that reduces at least one of:
inter-frame movement of said objects in said sequence of miniaturized image frames; and
high spatial frequency data in said sequence of miniaturized image frames;
compressing said sequence of miniaturized image frames into a dynamic data layer and said quasi-static background into a quasi-static data layer; and
encoding said dynamic data layer and said quasi-static data layer with setting metadata pertaining to said scene and said at least one ultra-high resolution camera, and corresponding consolidated formatting metadata pertaining to said decomposing procedure and said formatting procedure.

2. The method according to claim 1, further comprising an initial procedure of calibrating the respective position and orientation of each of said at least one ultra-high resolution camera in relation to a global coordinate system associated with said scene, thereby defining said setting metadata.

3. The method according to claim 2, further comprising a preliminary procedure of determining said setting metadata which includes a scene model describing spatial characteristics pertaining to said scene, a camera model describing respective extrinsic and intrinsic parameters of each of said at least one ultra-high resolution camera, and data yielded from said calibrating procedure.

4. The method according to claim 3, wherein said calibrating procedure facilitates generation of back-projection functions that transform from respective image coordinates of said sequential image frames captured from said at least one ultra-high resolution camera to said global coordinate system.

5. The method according to claim 1, wherein said consolidated formatting metadata includes information that describes data contents of formatted said dynamic image features.

6. The method according to claim 1, wherein a miniaturized image frame in said sequence of miniaturized image frames includes a respective miniature image of said object, recognized from said dynamic image features.

7. The method according to claim 5, wherein said consolidated formatting metadata includes at least one of: correspondence data that associates a particular identified said object with its position in said sequence of miniaturized image frames, specifications of said sequence of miniaturized image frames, and data specifying reduction of said high spatial frequency data.

8. The method according to claim 1, further comprising the procedure of transmitting encoded said dynamic data layer and said quasi-static data layer with said setting metadata and encoded said consolidated formatting metadata.

9. The method according to claim 1, further comprising a procedure of completing said quasi-static background in areas of said sequential image frames where former positions of said dynamic images features were assumed prior to said procedure of decomposition.

10. The method according to claim 1, wherein said sequence of miniaturized image frames and said quasi-static background are compressed separately in said compressing procedure.

11. The method according to claim 1, further comprising a procedure of decoding the encoded said quasi-static data layer, and the encoded said dynamic data layer with corresponding encoded said consolidated formatting metadata, and with said setting metadata, so as to respectively generate a decoded quasi-static data layer, a decoded dynamic data layer, and decoded consolidated formatting metadata.

12. The method according to claim 11, further comprising a procedure of decompressing said decoded quasi-static layer, said decoded dynamic data layer, and said decoded consolidated formatting metadata.

13. The method according to claim 1, wherein each of said at least one ultra-high resolution camera has a different said fixed viewpoint of said scene.

14. The method according to claim 4, further comprising a procedure of receiving as input a user-selected virtual camera viewpoint of said scene that is different from said fixed viewpoint captured from said at least one ultra-high resolution camera, said user-selected virtual camera viewpoint is associated with a virtual camera coordinate system in relation to said global coordinate system.

15. The method according to claim 14, further comprising a procedure of generating from said sequential image frames a rendered output video stream that includes a plurality of rendered image frames, using said setting metadata and given input relating to said user-selected virtual camera viewpoint.

16. The method according to claim 15, wherein said rendered output video stream is generated in particular, by mapping each of said back-projection functions each associated with a respective said at least one ultra-high resolution camera onto said virtual camera coordinate system, thereby creating a set of three-dimensional (3-D) data points that are projected onto a two-dimensional surface so as to yield said rendered image frames.

17. The method according to claim 15, wherein said rendered image frames include at least one of: a representation of at least part of said quasi-static data layer, and a representation of at least part of said dynamic data layer respectively corresponding to said dynamic image features, wherein said consolidated formatting metadata determines the positions and orientations of said dynamic image features in said rendered image frames.

18. The method according to claim 17, further comprising a procedure of incorporating graphics content into said rendered image frames.

19. The method according to claim 17, further comprising a procedure of displaying said rendered image frames.

20. The method according claim 19, further comprising a procedure of providing information about a particular said object exhibited in displayed said rendered image frames, in response to user input.

21. The method according to claim 19, further comprising a procedure of providing a selectable viewing mode of displayed said rendered image frames.

22. The method according to claim 21, wherein said selectable viewing mode is selected from a list consisting of:
zoom-in viewing mode;
zoom-out viewing mode;
object tracking viewing mode;
viewing mode where imaged said scene matches said fixed viewpoint generated from one of said ultra-high resolution cameras;
user-selected manual display viewing mode;
follow-the-anchor viewing mode;
user-interactive viewing mode; and
simultaneous viewing mode.

23. The method according to claim 1, further comprising a procedure of synchronizing each of said at least one ultra-high resolution camera to a reference time.

24. The method according to claim 11, wherein said encoding and said decoding are performed in real-time.

25. The method according to claim 1, wherein at least two of said at least one ultra-high resolution camera is configured as adjacent pairs, where each of said at least one ultra-high resolution camera in a pair is operative to substantially capture said sequential image frames from different complementary areas of said scene.

26. The method according to claim 25, further comprising a procedure of calibrating between said adjacent pairs so as to minimize the effect of parallax.

27. The method according to claim 25, wherein at least two of said at least one ultra-high resolution camera is configured so as to provide stereoscopic image capture of said scene.

28. The method according to claim 1, wherein said sequential image frames of said video stream have a resolution of at least 8 megapixels.

29. The method according to claim 1, wherein said scene includes a sport playing ground/pitch.

30. The method according to claim 29, wherein said sport playing ground/pitch is selected from a list consisting of:
soccer/football field;
Gaelic football/rugby pitch;
basketball court;
baseball field;
tennis court;
cricket pitch;
hockey filed;
ice hockey rink;
volleyball court;
badminton court;
velodrome;
speed skating rink;
curling rink;
equine sports track;
polo field;
tag games fields;
archery field;
fistball field;
handball field;
dodgeball court;
swimming pool;
combat sports rings/areas;
cue sports tables;
flying disc sports fields;
running tracks;
ice rink;
snow sports areas;
Olympic sports stadium;
golf field;
gymnastics arena;
motor racing track/circuit;
card games tables/spaces;
board games boards;
table sports tables;
casino games areas;
gambling tables;
performing arts stages;
auction areas; and
dancing ground.

31. A system for providing ultra-high resolution video, the system comprising:
at least one ultra-high resolution camera that captures a plurality of sequential image frames from a fixed viewpoint of a scene;
a server node comprising:
a server processor coupled with said at least one ultra-high resolution camera, said server processor decomposes said sequential image frames into quasi-static background and dynamic image features thereby yielding decomposition metadata, said server processor distinguishes between different objects represented by said dynamic image features by recognizing characteristics of said objects and by tracking movement of said objects in said sequential image frames, said server processor formatting said dynamic image features into a sequence of miniaturized image frames that reduces at least one of: inter-frame movement of said objects in said sequence of miniaturized image frames; and high spatial frequency data in said sequence of miniaturized image frames, thereby yielding formatting metadata; said server processor compresses said sequence of miniaturized image frames into a dynamic data layer and said quasi-static background into a quasi-static data layer, said server processor encodes said dynamic data layer and said quasi-static data layer with metadata that includes setting metadata pertaining to said scene and said at least one ultra-high resolution camera, and consolidated formatting metadata that includes said decomposition metadata and said formatting metadata; and
a server communication module, coupled with said server processor, for transmitting encoded said dynamic data layer and encoded said quasi-static data layer; and
at least one client node communicatively coupled with said server node, said at least one client node comprising:
a client communication module for receiving encoded said metadata, encoded said dynamic data layer and encoded said quasi-static data layer; and
a client processor, coupled with said client communication module, said client processor decodes and combines encoded said dynamic data layer and encoded said quasi-static data layer, according to said metadata that includes said consolidated formatting metadata, so as to generate an output video stream that reconstructs said sequential image frames.

32. The system according to claim 31, wherein the position and orientation of each of said at least one ultra-high resolution camera in relation to a global coordinate system associated with said scene are calibrated and recorded by said server node, thereby defining said setting metadata.

33. The system according to claim 32, wherein said setting metadata includes a scene model describing spatial characteristics pertaining to said scene, a camera model describing respective extrinsic and intrinsic parameters of each of said at least one ultra-high resolution camera, and data yielded from calibration.

34. The system according to claim 33, wherein said server node generates, via said calibration, back-projection functions that transform from respective said image coordinates of said sequential image frames captured from said at least one ultra-high resolution camera to said global coordinate system.

35. The system according to claim 31, wherein said consolidated formatting metadata includes information that describes data contents of formatted said dynamic image features.

36. The system according to claim 31, wherein a miniaturized image frame in said sequence of miniaturized image frames includes a respective miniature image of said object, recognized from said dynamic image features.

37. The system according to claim 35, wherein said consolidated formatting metadata includes at least one of: correspondence data that associates a particular identified said object with its position in said sequence of miniaturized image frames, specifications of said sequence of miniaturized image frames, and data specifying reduction of said high spatial frequency data.

38. The system according to claim 31, wherein said server node completes said quasi-static background in areas of said sequential image frames where former positions of said dynamic images features were assumed prior to decomposition.

39. The system according to claim 31, wherein said sequence of miniaturized image frames and said quasi-static background are compressed separately.

40. The system according to claim 31, wherein said client node generates decoded quasi-static data layer from received said encoded quasi-static data layer, and decoded dynamic data layer from received said encoded dynamic data layer, with corresponding said consolidated formatting metadata.

41. The system according to claim 40, wherein said client node decompresses said decoded quasi-static layer, said decoded dynamic data layer, and said decoded metadata.

42. The system according to claim 31, wherein each of said at least one ultra-high resolution camera has a different said fixed viewpoint of said scene.

43. The system according to claim 34, wherein said client node receives as input a user-selected virtual camera viewpoint of said scene that is different from said fixed viewpoint captured from said at least one ultra-high resolution camera, said user-selected virtual camera viewpoint is associated with a virtual camera coordinate system in relation to said global coordinate system.

44. The system according to claim 43, wherein said client node generates from said sequential image frames a rendered output video stream that includes a plurality of rendered image frames, using said setting metadata and given input relating to said user-selected virtual camera viewpoint.

45. The system according to claim 44, wherein said rendered output video stream is generated in particular, by mapping each of said back-projection functions each associated with a respective said at least one ultra-high resolution camera onto said virtual camera coordinate system, thereby creating a set of three-dimensional (3-D) data points that are projected onto a two-dimensional surface so as to yield said rendered image frames.

46. The system according to claim 44, wherein said rendered image frames include at least one of: a representation of at least part of said quasi-static data layer, and a representation of at least part of said dynamic data layer respectively corresponding to said dynamic image features, wherein said consolidated formatting metadata determines the positions and orientations of said dynamic image features in said rendered image frames.

47. The system according to claim 46, wherein said client node incorporates graphics content into said rendered image frames.

48. The system according to claim 46, further comprising a client display coupled with said client processor for displaying said rendered image frames.

49. The system according claim 48, wherein said client node provides information about a particular said object exhibited in displayed said rendered image frames, in response to user input.

50. The system according to claim 48, further comprising a procedure of providing a selectable viewing mode of displayed said rendered image frames.

51. The system according to claim 50, wherein said selectable viewing mode is selected from a list consisting of:
zoom-in viewing mode;
zoom-out viewing mode;
object tracking viewing mode;
viewing mode where imaged said scene matches said fixed viewpoint generated from one of said ultra-high resolution cameras;
user-selected manual display viewing mode;
follow-the-anchor viewing mode;
user-interactive viewing mode; and
simultaneous viewing mode.

52. The system according to claim 31, wherein said server node synchronizes each of said at least one ultra-high resolution camera to a reference time.

53. The system according to claim 41, wherein said encoding and said decoding are performed in real-time.

54. The system according to claim 31, wherein at least two of said at least one ultra-high resolution camera is configured as adjacent pairs, where each of said at least one ultra-high resolution camera in a pair is operative to substantially capture said sequential image frames from different complementary areas of said scene.

55. The system according to claim 54, wherein said adjacent pairs are calibrated so as to minimize the effect of parallax.

56. The system according to claim 55, wherein at least two of said at least one ultra-high resolution camera is configured so as to provide stereoscopic image capture of said scene.

57. The system according to claim 31, wherein said sequential image frames of said video stream have a resolution of at least 8 megapixels.

58. The system according to claim 31, wherein said scene includes a sport playing ground/pitch.

59. The system according to claim 58, wherein said sport playing ground/pitch is selected from a list consisting of:
soccer/football field;
Gaelic football/rugby pitch;
basketball court;
baseball field;
tennis court;
cricket pitch;
hockey filed;
ice hockey rink;
volleyball court;
badminton court;
velodrome;
speed skating rink;
curling rink;
equine sports track;
polo field;
tag games fields;
archery field;
fistball field;
handball field;
dodgeball court;
swimming pool;
combat sports rings/areas;
cue sports tables;
flying disc sports fields;
running tracks;
ice rink;
snow sports areas;
Olympic sports stadium;
golf field;
gymnastics arena;
motor racing track/circuit;
card games tables/spaces;
board games boards;
table sports tables;
casino games areas;
gambling tables;
performing arts stages;
auction areas; and
dancing ground.
